(19) United States
(12) Patent Application Publication
(10) Pub. No.: US 2017/0057434 A1
(43) Pub. Date: Mar. 2, 2017

(54) WIRING HARNESS ROUTING STRUCTURE

(71) Applicant: YAZAKI CORPORATION, Tokyo (JP)

(72) Inventors: Tetsuo NOHARA, Utsunomiya-shi (JP); Shintaro SUZUKI, Utsunomiya-shi (JP); Bunpei MUTO, Utsunomiya-shi (JP); Shinichi AKIYAMA, Utsunomiya-shi (JP)

(73) Assignee: YAZAKI CORPORATION, Tokyo (JP)

(21) Appl. No.: 15/350,282

(22) Filed: Nov. 14, 2016

Related U.S. Application Data
(63) Continuation of application No. PCT/JP2015/066416, filed on Jun. 5, 2015.

(30) Foreign Application Priority Data
Jun. 6, 2014 (JP) 2014-117715
Jun. 6, 2014 (JP) 2014-117716
Jun. 6, 2014 (JP) 2014-117717

(51) Int. Cl. B60R 16/02; H01B 7/00

(52) U.S. Cl. CPC B60R 16/0215; H01B 7/0045

(57) ABSTRACT

A wiring harness routing structure includes a wiring harness routing member configured to be attached to a vehicle body and a protector that accommodates and holds a wiring harness. The protector has a recess shape in which the protector is opened in one direction in a sectional view. At least one of the wiring harness routing member and the protector includes a fixing mechanism that fixes the protector to the wiring harness routing member. The protector and the wiring harness routing member are configured to be integrated via the fixing mechanism.

### CROSS REFERENCE TO RELATED APPLICATIONS

This application is a continuation of PCT application No. PCT/JP2015/066416, which was filed on Jun. 5, 2015 based on Japanese Patent Application (No. 2014-117715) filed on Jun. 6, 2014, Japanese Patent Application (No. 2014-117716) filed on Jun. 6, 2014, and Japanese Patent Application (No. 2014-117717) filed on Jun. 6, 2014, the contents of which are incorporated herein by reference.

### BACKGROUND OF THE INVENTION

Field of the Invention

The present invention relates to a wiring harness routing structure.

Description of Related Art

In the related art, in the manufacturing of a vehicle wiring harness, first, fork-shaped jigs are provided along a routing path on a routing plate. Subsequently, electrical cables to which connectors, terminals, and the like are connected are routed along the routing path using the jigs. Subsequently, exterior members such as a protector and a corrugated tube are attached to the routed electrical cables. Subsequently, the exterior members and the electrical cables are fixed together with adhesive tape. After being tested for conductivity, a wiring harness manufactured in this manner is attached to a routing target in a vehicle. Patent Literature 1 (JP-A-2003-45255) discloses this type of technology.

In contrast, a beam (also referred to as a reinforcement), which is a reinforcement member to which a wiring harness is attached, is disposed in a deep portion of an instrument panel of a vehicle. In order to attach the wiring harness to the beam, for example, clips are mounted as a fixation member to an exterior member of the wiring harness, and are fixed thereto with adhesive tape or the like, and the beam is provided with clip holes with which the clips are respectively engaged. If the clips integrated with the wiring harness are respectively engaged with the clip holes of the beam, the wiring harness is fixed to the beam.

### [Patent Literature 1] JP-A-2003-45255

### SUMMARY OF INVENTION

### Technical Problems

According to a related art, in the manufacturing of a wiring harness, since fork-shaped jigs are provided on a jig plate, and electrical cables are routed in a state of being hung around the jigs, there is a problem in that the manufacturing of a wiring harness requires a significant amount of labor and time.

Since the manufactured wiring harness has flexibility, there is a problem in that handling during transportation is not easy.

In order to attach a wiring harness to a beam, a fixation member such as a clip is separately required, and an operation of mounting and fixing the fixation member to the wiring harness is also required.

Accordingly, there is a problem in that an operation from when a wiring harness is manufactured until the wiring harness is routed at a routing location of an attachment target includes a large number of steps, and an attachment operation is complex.

### SUMMARY

One or more embodiments provide a wiring harness routing structure in which the manufacturing, handling, and routing of a wiring harness are easy.

In an aspect (1), one or more embodiments provide a wiring harness routing structure including a wiring harness routing member configured to be attached to a vehicle body and a protector that accommodates and holds a wiring harness. The protector has a recess shape in which the protector is open in one direction in a sectional view. At least one of the wiring harness routing member and the protector includes a fixing mechanism that fixes the protector to the wiring harness routing member. The protector and the wiring harness routing member are integrated via the fixing mechanism.

In an aspect (2), a contact surface of the protector which is in contact with the wiring harness routing member has a shape conforming to the shape of a contact surface of the wiring harness routing member.

In an aspect (3), the fixing mechanism includes a bracket that is provided in the wiring harness routing member, and a clip that is formed integrally with the protector and includes a hole portion that is engaged with the bracket.

In an aspect (4), the wiring harness includes a joint connector with a rectification function, and the protector includes a joint connector accommodation portion.

In an aspect (5), the protector includes a main cable accommodation portion that accommodates a main cable of the wiring harness, and a branch cable accommodation portion that accommodates a branch cable of the wiring harness.

According to the aspect (1), the protector has a recess shape in which the protector is open in one direction in a sectional view, and thus, the protector is capable of accommodating the wiring harness in a state where the protector is mounted with an open portion of the protector facing upward. Accordingly, it is possible to easily route the wiring harness inside the protector without using the fork-shaped jigs used in the related art.

According to the aspect (1), the protector and the wiring harness routing member are integrated via the fixing mechanism, and thus, it is easy to handle the wiring harness. At a site where wiring harnesses are routed in a vehicle, it is possible to easily route the wiring harness by simply attaching the routing member, with which the wiring harness is integrated via the protector, to the vehicle.

According to the aspect (2), the contact surface of the protector which is in contact with the wiring harness routing member has a shape conforming to the shape of the contact surface of the wiring harness routing member, and the protector is in close contact with a contact member of the wiring harness, and thus, the protector is integrated with the wiring harness routing member without the occurrence of rattling.

According to the aspect (3), the fixing mechanism with a simple configuration can be configured of the bracket provided in the wiring harness routing member, and the clip formed integrally with the protector.

According to the aspect (4), even if the wiring harness includes the joint connector with a rectification function, since the joint connector is accommodated in the joint connector accommodation portion of the protector, the joint connector is also integrated with the protector together with wiring harness. Accordingly, the joint connector does not swing around during handling, and good operability is obtained.

According to the aspect (5), even if the wiring harness includes the main cable and the branch cable, it is possible to route the wiring harness inside the protector without using the fork-shaped jigs used in the related art.

According to one or more embodiments, it is possible to provide a wiring harness routing structure in which the manufacturing, handling, and routing of a wiring harness are easy.

### BRIEF DESCRIPTION OF THE DRAWINGS

FIG. 1 is an exploded perspective view of a wiring harness routing structure according to an embodiment of the present invention.

FIG. 2 is a perspective view of a protector.

FIG. 3 is a perspective view of a fixing mechanism that fixes the protector to a beam.

FIG. 4 is a sectional view of the fixing mechanism illustrated in FIG. 3.

FIG. 5 is a perspective view of a modification example of the protector.

FIG. 6 is a plan view illustrating an example of the entire configuration of a wiring harness in a first example of a second embodiment.

FIG. 7 is a plan view illustrating each configuration element prepared to form the wiring harness illustrated in FIG. 6.

FIGS. 8A and 8B are plan views illustrating the configurations of two types of connection units which can be used to form a wiring harness in a second example of the second embodiment.

FIG. 9 is a plan view illustrating the configuration of each sub-harness group which can be used to form the wiring harness in the second example of the second embodiment.

FIGS. 10A and 10B are plan views illustrating examples of the configurations of two types of wiring harnesses in the second example of the second embodiment.

FIG. 11 is a plan view illustrating an example of the configurations of a typical wiring harness and sub-harnesses.

FIG. 12 is a plan view illustrating an example of the entire configuration of a wiring harness in a first example of a third embodiment.

FIG. 13 is a plan view illustrating each configuration element prepared to form a wiring harness illustrated in FIG. 1.

FIGS. 14A and 14B are plan views illustrating the configurations of two types of connection units which can be used to form a wiring harness in a second example of the third embodiment.

FIG. 15 is a plan view illustrating the configuration of each sub-harness group which can be used to form the wiring harness in the second example of the third embodiment.

FIGS. 16A and 16B are plan views illustrating examples of the configurations of two types of wiring harnesses in the second example of the third embodiment.

FIG. 17 is a plan view illustrating an example of the configurations of a typical wiring harness and sub-harnesses.

### DETAILED DESCRIPTION

### First Embodiment

First embodiment is described with reference to the accompanying drawings.

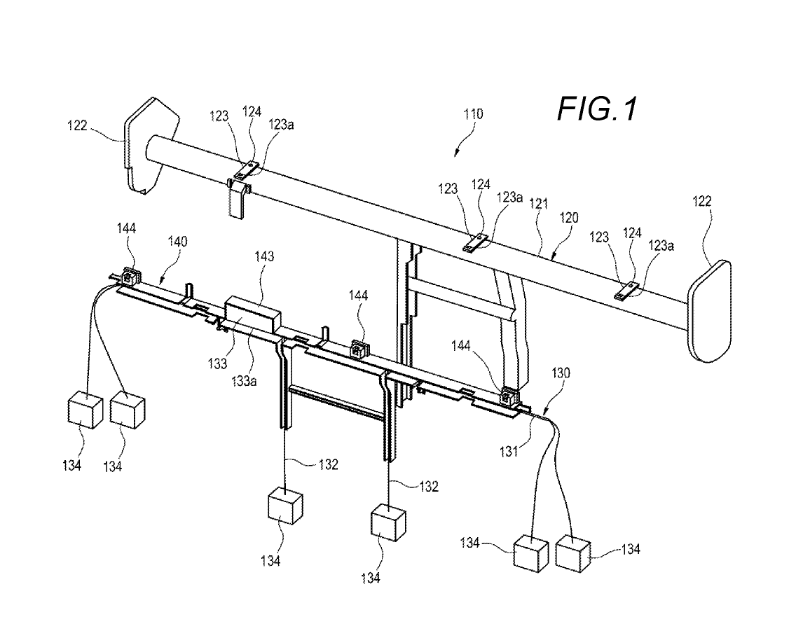

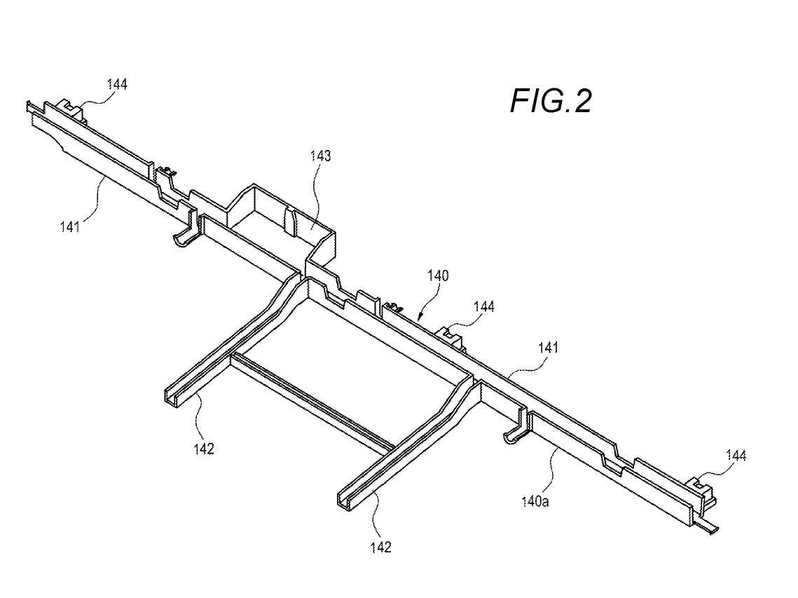

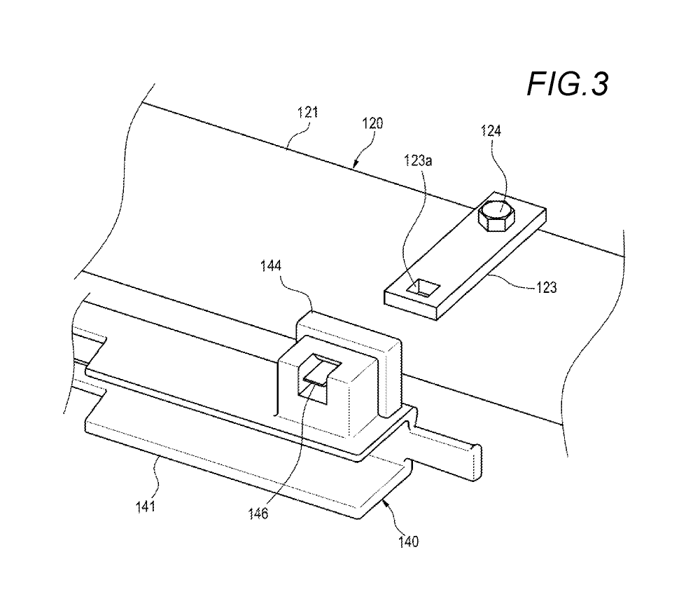

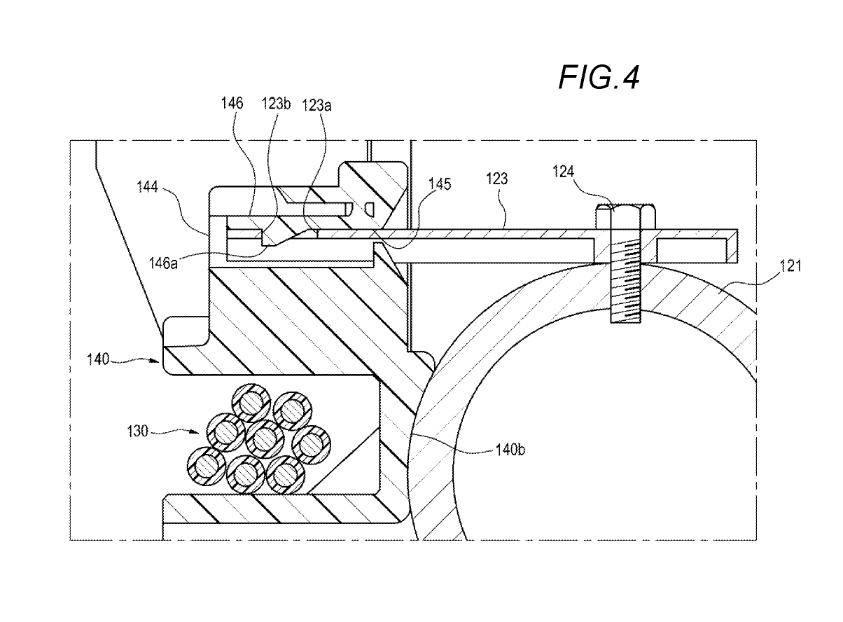

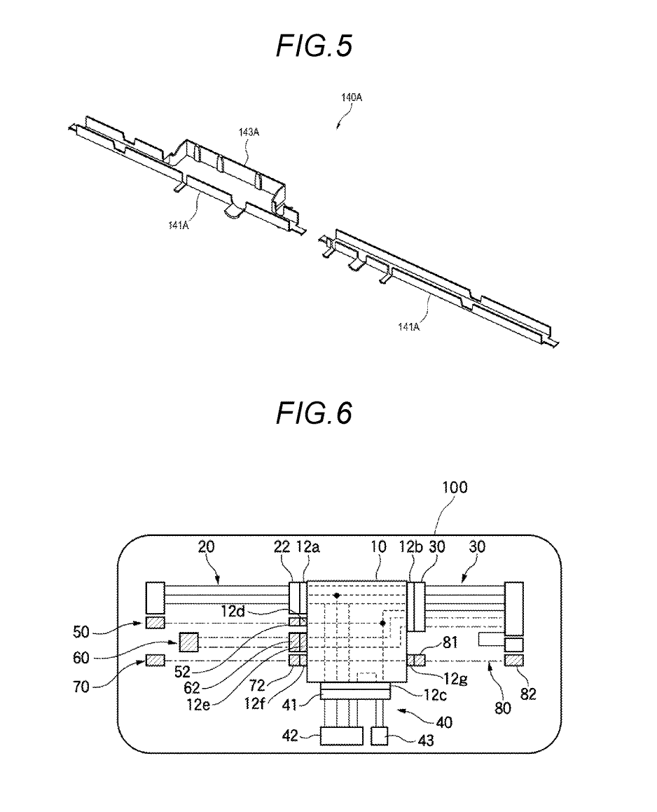

FIG. 1 is an exploded perspective view of a wiring harness routing structure according to an embodiment of the present invention. FIG. 2 is a perspective view of a protector. FIG. 3 is a perspective view of a fixing mechanism that fixes the protector to a beam. FIG. 4 is a sectional view of the fixing mechanism illustrated in FIG. 3. FIG. 5 is a perspective view of a modification example of the protector.

As illustrated in FIG. 1, a wiring harness routing structure 110 includes a beam 120 that is provided in a deep portion of an instrument panel of a vehicle; a wiring harness 130 through which an electricity supply is electrically connected to various devices; and a protector 140 that accommodates the wiring harness 130. The beam 120 is a rigid body, and is disposed along a width direction of the vehicle.

The wiring harness 130 includes an electrical cable (hereinafter, also simply referred to as a main cable) which is a main cable 131, and electrical cables (hereinafter, also simply referred to as branch cables) which are multiple branch cables 132 branched from the main cable 131. First ends of the main cable 131 and the branch cables 132 of the wiring harness 130 are connected to a joint connector 133 with a rectification function via connectors (not illustrated). The joint connector 133 has a substantially rectangular parallelepiped shape. The first ends of the main cable 131 and the branch cables 132 are connected to only one surface (connection surface) 133a of the joint connector 133. The wiring harness 130 includes connectors 134 at second ends of the main cable 131 and the branch cables 132, and the connectors 134 are respectively connected to various devices in the vehicle. The main cable 131 and the branch cables 132 are connected together in a predetermined state inside the joint connector 133.

The protector 140 is made of synthetic resin. As illustrated in FIG. 2, the protector 140 includes a main cable accommodation portion 141 that accommodates the main cable 131 of the wiring harness 130, and branch cable accommodating portions 142 which respectively accommodate the branch cables 132 branched from the main cable 131. The wiring harness 130 is accommodated in and held by protector 140 in a state where the wiring harness 130 is branched. The protector 140 is formed into a shape in which the lateral sections of the main cable accommodation portion 141 and the branch cable accommodation portions 142 have a recess shape (U shape). The protector 140 has a substantially T shape in a plan view. The protector 140 includes a joint connector accommodation portion 143 that accommodates the joint connector 133. The joint connector accommodation portion 143 is provided adjacent to the main cable accommodation portion 141, and communicates to the main cable accommodation portion 141.

The joint connector accommodation portion 143 preferably fixes the joint connector 133 in a weak press-fit state. In addition, preferably, the main cable accommodation portion 141 and the branch cable accommodation portions 142 respectively fix the main cable 131 and the branch cables 132 in a weak press-fit state. In this configuration, it is possible to accommodate and hold the joint connector 133, the main cable 131, and the branch cables 132 in the protector 140 without using separate components as holding tools.

The main cable accommodation portion 141 of the protector 140 is fixed to the beam 120. For this reason, the main cable accommodation portion 141 of the protector 140 is formed into a longitudinal shape conforming to the longitudinal shape of the beam 120. A bottom surface 140a of the protector 140 is substantially flat, and can be stably mounted on a routing plate. The protector 140 has such rigidity that the protector 140 is not bent when being carried in a state where the protector 140 accommodates the wiring harness 130 and the joint connector 133.

Clips 144 are molded integrally with the protector 140 so as to attach the protector 140 to the beam 120. In the embodiment, three clips 144 are formed integrally with the protector.

Flanges 122 are respectively provided at both ends of a hollow cylindrical shaft portion 121 of the beam 120 so as to fix the beam 120 to a vehicle body. A plate-shaped bracket 123 is provided in the beam 120 at a position corresponding to the clip 144 of the protector 140. A proximal portion of the bracket 123 is fixed to the shaft portion 121 with a screw 124. An engagement hole 123a is formed on a distal side of the bracket 123 so as to fix the clip.

The beam 120 is a rigid body. In the embodiment, the beam 120 is made of steel, and if required rigidity can be obtained, the beam 120 may be made of resin or a ceramic.

A slit 145 (refer to FIG. 4) is formed in the clip 144 of the protector 140, and the bracket 123 is inserted into the slit 145. The clip 144 is provided with a lock arm 146 that is supported in a cantilever manner and can be elastically deformed. The lock arm 146 is provided with a claw portion 146a that is engaged with an edge portion 123b of the engagement hole 123a of the bracket 123 inserted into the slit 145. The claw portions 146a of the lock arms 146 are respectively engaged with the edge portions 123b of the engagement holes 123a of the bracket 123 such that the separation of the clips 144 from the brackets 123 is prevented.

In the embodiment, the fixing mechanism of the present invention is configured of the clips 144 of the protector 140 and the brackets 123 of the beam 120.

The protector 140 accommodating the wiring harness 130 and the joint connector 133 is mounted on the beam 120 such that the brackets 123 of the beam 120 are respectively inserted into the slits 145 of the clips 144. If the brackets 123 of the beam 120 are suitably respectively inserted into the slits 145 of the clips 144, the claw portions 146a of the lock arms 146 of the clips 144 are respectively engaged with the edge portions 123b of the engagement holes 123a of the brackets 123, and the clips 144 and the brackets 123 are unseparably fixed together. Accordingly, the protector 140 accommodating the wiring harness 130 and the joint connector 133 is reliably fixed to the beam 120. As illustrated in FIG. 4, a contact surface 140b of the protector 140 which is in contact with the beam 120 has a circular arc shape conforming to the shape of a peripheral surface of the beam 120. Accordingly, the protector 140 is fixed to the beam 120 without the occurrence of rattling while being in a close contact with the beam 120.

Hereinafter, a method of assembling the wiring harness routing structure 110 of the embodiment will be described.

First of all, an operator connects the first ends of the main cable 131 and the branch cables 132 to the joint connector 133, and respectively connects the second ends of the main cable 131 and the branch cables 132 to the connectors 134 for various devices.

Subsequently, the operator mounts the protector 140 on a routing plate (not illustrated) with an opening portion of the protector 140 facing upward. Subsequently, the joint connector 133 is accommodated in the joint connector accommodation portion 143, and the main cable 131 is accommodated in the main cable accommodation portion 141. Subsequently, the branch cables 132 are branched from the main cable 131 via the branch cable accommodation portions 142, and the branch cables 132 are accommodated in the branch cable accommodation portions 142. In this manner, the wiring harness 130 held and branched by the protector 140 is manufactured. The joint connector 133 is accommodated such that the connection surface 133a, which is connected to the main cable 131 and the branch cables 132, faces a main cable accommodation portion 141 side. In this setting, an excessive load is not applied to the main cable 131 and the branch cables 132 routed from the joint connector 133.

Subsequently, the operator attaches the protector 140, which has accommodated the wiring harness 130, to the beam 120. Specifically, the operator assembles the protector 140 to the beam 120 such that the brackets 123 of the beam 120 are respectively inserted into the slits 145 of the clips 144 of the protector 140. If the brackets 123 are respectively inserted a suitable distance into the slits 145 of the clips 144, the claw portions 146a of the lock arms 146 of the clips 144 are respectively engaged with into the engagement holes 123a of the brackets 123, and the clips 144 and the brackets 123 are completely fixed together. Accordingly, the protector 140 accommodating the wiring harness 130 is integrally fixed to the beam 120, and the wiring harness routing structure 110 is completed.

After being tested for conductivity, a completed wiring harness routing structure 110 is transported to a location where the completed wiring harness routing structure 110 is attached to a vehicle, and is attached to a deep portion of an instrument panel of the vehicle. The attached wiring harness routing structure 110 is electrically connected to various devices via the connectors 134 of end portions of the main cable 131 and the branch cables 132.

In the wiring harness routing structure 110 of the embodiment, the protector 140 has a recess shape in which the protector 140 is open in one direction in a sectional view, and thus, the protector 140 is capable of accommodating the wiring harness 130 in a state where the protector 140 is mounted with an open portion of the protector 140 facing upward. Accordingly, it is possible to easily route the wiring harness 130 inside the protector 140 without using fork-shaped jigs used in the related art.

In the wiring harness routing structure 110 of the embodiment, the protector 140 and the beam 120 are integrated via the clips 144 and the brackets 123, and thus, it is easy to handle the wiring harness 130. At a site where wiring harnesses are routed in the vehicle, it is possible to easily route the wiring harness 130 merely by attaching the beam 120, with which the wiring harness 130 is integrated via the protector 140, to the vehicle.

As a result, according to the embodiment, it is possible to provide the wiring harness routing structure 110 in which the manufacturing, handling, and routing of the wiring harness 130 are easy.

The present invention is not limited to the aforementioned embodiment, and the embodiment can be suitably modified or improved. Insofar as an object of the present invention can be achieved, the material, shape, dimensions, and disposition location of each configuration element, and the number of configuration elements may be arbitrarily determined, and are not specifically limited.

The protector 140 of the embodiment is an integrally molded object having a substantially T shape. Alternatively, as illustrated in FIG. 5, a protector 140A may be divided in a longitudinal direction. If the protector 140A is divided, it is possible to transport the protector 140A in a compact state. If multiple divided protector bodies 141A are prepared, it is possible to cope with multiple branch routing forms and multiple joint connectors having different shapes. For this reason, a joint connector accommodation portion 143A having a different shape is formed.

In the embodiment, the fixing mechanism for fixing the protector 140 to the beam 120 is configured to use the plate-shaped brackets 123. Alternatively, round bar-shaped or square bar-shaped brackets may be used, and the slits 145 of the clips 144 may be holes with which the round bar-shaped or square bar-shaped brackets are respectively engaged.

The fixing mechanism may be provided in only one of the beam 120 and the protector 140.

A wiring harness routing member of the embodiment is the beam 120 that is disposed in a deep portion of an instrument panel. Alternatively, a wiring harness routing member may be a member through which a wiring harness is routed in a door panel, a floor panel, a ceiling panel, or the like.

The aforementioned characteristics of the wiring harness routing structure according to the embodiment of the present invention are briefly summarized and listed in [1] to [5].

[1] A wiring harness routing structure (110) includes a wiring harness routing member (beam 120) configured to be attached to a vehicle body, and a protector (140) that accommodates and holds a wiring harness (130). The protector (140) has a recess shape in which the protector (140) is opened in one direction in a sectional view. At least one of the wiring harness routing member (120) and the protector (140) includes a fixing mechanism (bracket 123 and clip 144) that fixes the protector (140) to the wiring harness routing member (120). The protector (140) and the wiring harness routing member (120) are configured to be integrated via the fixing mechanism (bracket 123 and clip 144).

[2] In the wiring harness routing structure (110) described in [1], the protector (140) includes a contact surface (140b) which is configured to be in contact with the wiring harness routing member (120). The contact surface (140b) of the protector (140) has a shape conforming to a shape of a contact surface of the wiring harness routing member (120).

[3] In the wiring harness routing structure (110) described in [1] or [2], the fixing mechanism (123 and 144) includes a bracket (123) provided with the wiring harness routing member (120), and a clip (144) formed integrally with the protector (140) and including a hole portion (slit 145) that is engaged with the bracket (123).

[4] In the wiring harness routing structure (110) described in any one of [1] to [3], the wiring harness (130) includes a joint connector (133) with a rectification function, and the protector (140) includes a joint connector accommodation portion (143).

[5] In the wiring harness routing structure (110) described in any one of [1] to [4], the protector (140) includes a main cable accommodation portion (141) that accommodates a main cable (131) of the wiring harness (130), and a branch cable accommodation portion (142) that accommodates a branch cable (132) of the wiring harness (130).

### Second Embodiment

The wiring harness routing structure of the first embodiment can be applied to wiring harnesses to be described below. Hereinafter, a wiring harness of a second embodiment will be described.

### BACKGROUND OF THE INVENTION

Field of the Invention

The second embodiment relates to a wiring harness that is formed of multiple sub-harnesses.

Description of Related Art

Patent Literature 2 and Patent Literature 3 disclose the related art relating to a wiring harness used in a vehicle. As illustrated in FIG. 1 of Patent Literature 2, typically, such a wiring harness is an aggregate of bundled multiple sub-harnesses which are respectively prepared for systems. Sub-harnesses to be bundled together differ according to the required specifications of the wiring harness.

Specifically, the required electrical components of a vehicle differ according to the type, grade, or required options of the vehicle. For this reason, circuit cables of an electricity supply cable, a ground cable, a signal cable, and a communication cable, which are connected to each electrical component, differ. A sub-harness represents a set of circuit cables for driving an electrical system which are bundled together according to electrical systems so as to cope with such a difference between the circuit cables. One wiring harness is formed by selecting sub-harnesses according to the required specifications corresponding to a vehicle type, a grade, or an option, and by bundling together the sub-harnesses.

### [Patent Literature 2] JP-A-2001-160464

### [Patent Literature 3] JP-A-2001-169433

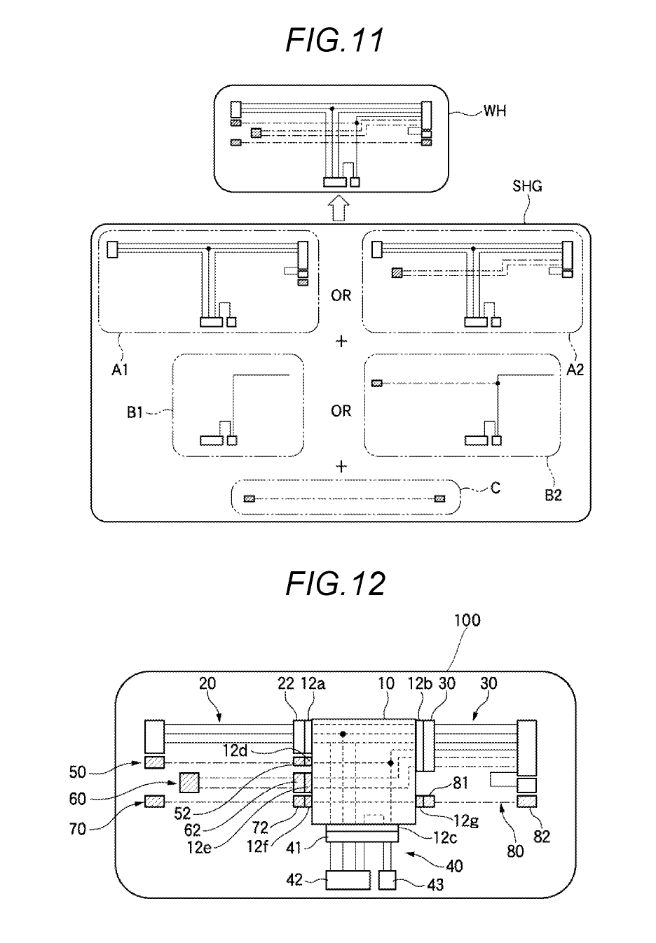

FIG. 11 illustrates a relationship between an example of a specific configuration of a wiring harness WH and multiple types of sub-harnesses which are prepared in advance so as to form the wiring harness. Hereinafter, the example of the configuration of the wiring harness illustrated in FIG. 11 will be described.

In FIG. 11, sub-harnesses A1, A2, B1, B2, and C which form a sub-harness group SHG are prepared. Accordingly, the wiring harness WH can be formed by bundling together multiple sub-harnesses which are suitably selected from the sub-harness group SHG.

For example, the wiring harness WH can be formed as an assembly in which three sub-harnesses, that is, the sub-harness A2, the sub-harness B2, and the sub-harness C illustrated in FIG. 11, are combined together. It is necessary to change the configuration of the wiring harness WH so as to correspond to a difference between specifications such as the type, grade, and option of a vehicle in which the wiring harness WH is mounted. That is, the number of electrical cables, the existence and non-existence of connectors connected to each electrical cable, or the like of the wiring harness WH is suitably changed.

In the example illustrated in FIG. 11, it is possible to change the entire configuration of the wiring harness WH by changing a combination of sub-harnesses selected from the sub-harness group SHG as follows.

(1) The wiring harness WH is formed of a combination of three sub-harnesses, that is, the sub-harness A1, the sub-harness B1, and the sub-harness C.

(2) The wiring harness WH is formed of a combination of three sub-harnesses, that is, the sub-harness A2, the sub-harness B1, and the sub-harness C.

(3) The wiring harness WH is formed of a combination of three sub-harnesses, that is, the sub-harness A1, the sub-harness B2, and the sub-harness C.

(4) The wiring harness WH is formed of a combination of two sub-harnesses, that is, the sub-harness A1 and the sub-harness B1.

(5) The wiring harness WH is formed of a combination of two sub-harnesses, that is, the sub-harness A2 and the sub-harness B1.

(6) The wiring harness WH is formed of a combination of two sub-harnesses, that is, the sub-harness A1 and the sub-harness B2.

As such, a wiring harness corresponds to specifications which differ according to a vehicle type, a grade, or an option. As illustrated in FIG. 1 of Patent Literature 2, such a wiring harness is routed in a reinforcement. There is a wiring harness referred to as an instrument panel wiring harness.

The aforementioned current wiring harness or sub-harness includes standard circuits (illustrated by solid lines in FIG. 11, and hereinafter, may be referred to as standard circuit cables) which are inevitably used regardless of the type, grade, or option of a vehicle, and circuits (illustrated by alternating long and short dash lines in FIG. 11, and hereinafter, may be referred to as selective circuit cables) which are selectively added according to the vehicle type, the grade, or the option.

More sub-harnesses having different part numbers have to be prepared to the extent that the number of circuits selectively added to a sub-harness increases. Since the sub-harnesses A1 and A2 of the sub-harness group SHG illustrated in FIG. 11 include only one selectively added circuit, two types of sub-harnesses (A1 and A2) may be prepared. In contrast, if there are two selectively added circuits, four types of sub-harnesses are required. If there are three selectively added circuits, eight types of sub-harnesses are required. That is, the types (part numbers) of sub-harnesses which have to be prepared in advance exponentially increase.

In a case where a sub-harness is formed of a combination of standard circuit cables and selective circuit cables, the number of sub-harnesses which have to be managed tends to increase as the number of electrical components increases, or the number of vehicle types, the number of grades, or the number of options increases.

The second embodiment of the present invention is made in light of the aforementioned problem, and an object of the present invention is to provide a wiring harness in which it is possible to prevent an increase in the number of part numbers of sub-harnesses which have to be prepared in advance.

### SUMMARY

In order to achieve the aforementioned object, a wiring harness according to the second embodiment has the following characteristics in (1) to (5).

In an aspect (1), one or more embodiments provide a wiring harness including a first sub-harness including first circuit cables, a second sub-harness including second circuit cables, and a circuit substrate on which a circuit pattern, which can be connected to the first sub-harness and the second sub-harness, is formed. When the first sub-harness and the second sub-harness are connected to the circuit substrate, the first circuit cables and the second circuit cables are conductively connected together via the circuit pattern.

In an aspect (2), the circuit substrate includes multiple connection portions which can be attachably and detachably connected to end portions of multiple sub-harnesses including the first sub-harness and the second sub-harness.

In an aspect (3), the circuit pattern is formed on the circuit substrate so as to correspond to a difference between the types of multiple sub-harnesses including the first sub-harness and the second sub-harness which are connected according to required specifications.

In an aspect (4), the circuit substrate is a printed substrate that includes an electrical insulating substrate and a foil-shaped conductive pattern sticking to at least one surface of the substrate.

In an aspect (5), the circuit substrate is a multi-layer printed substrate which includes multiple electrical insulating layers that are disposed while being superimposed on top of each other in a thickness direction, and in which the multiple foil-shaped patterns electrically separated from each other are respectively formed at the boundaries and on front surfaces of the multiple electrical insulating layers.

According to the aspect (1), it is possible to control the existence and non-existence of connection between the first circuit cables and the second circuit cables, and the connection states of branch cables of the circuit cables via the circuit pattern inside the circuit substrate. Accordingly, even if various types of connection states are required in the entirety of the wiring harness, it is possible to simplify the configuration of each of the first sub-harness and the second sub-harness, and it is possible to reduce the number of types of sub-harnesses which have to be prepared in advance. In a case where a wiring harness is formed to connect a long distance path in its entirety, it is possible to use the first sub-harness and the second sub-harness of relatively short lengths.

According to the aspect (2), it is possible to easily realize a wiring harness with a configuration suitable for desired specifications merely by mounting multiple selected sub-harnesses on the circuit substrate via the connection portions.

According to the aspect (3), it is possible to realize a wiring harness suitable for various specifications via the configuration of the circuit pattern on the circuit substrate and the configurations of the first sub-harness and the second sub-harness which are selectively connected.

According to the aspect (4), it is possible to easily realize the circuit pattern that connects together the first circuit cables of the first sub-harness and the second circuit cables of the second sub-harness.

According to the aspect (5), insulating states of multiple independent circuit cables can be maintained at locations where the circuit cables intersect each other. As a result, it is possible to form a circuit pattern with a complex configuration, and it is possible to cope with an increase in the number of electrical cables of a wiring harness.

According to the wiring harness of the second embodiment, it is possible to prevent an increase in the number of part numbers of sub-harnesses which have to be prepared in advance. That is, since it is possible to switch the existence and non-existence of connection between the first circuit cables and the second circuit cables, and the connection states of branch cables of the circuit cables via the circuit pattern inside the circuit substrate, even if various types of connection states are required in the entirety of the wiring harness, it is possible to simplify the configuration of each of the first sub-harness and the second sub-harness. In a case where a wiring harness is formed to connect a long distance path in its entirety, it is possible to use the first sub-harness and the second sub-harness of relatively short lengths.

According to the wiring harness, it is possible to realize a wiring harness suitable for desired specifications by selecting a suitable circuit substrate from the first circuit substrate and the second circuit substrate, and by combining together the circuit substrate and at least two of the first sub-harness, the second sub-harness, and a third sub-harness. That is, it is possible to easily cope with requirements according to specifications via replacement of the circuit substrate.

### SUMMARY

One or more embodiments described below is read through with the accompanying drawings, details become further apparent.

Hereinafter, wiring harnesses of the second embodiment will be specifically described with reference to the drawings.

### First Example of Second Embodiment

### Entire Configuration of Wiring Harness 100

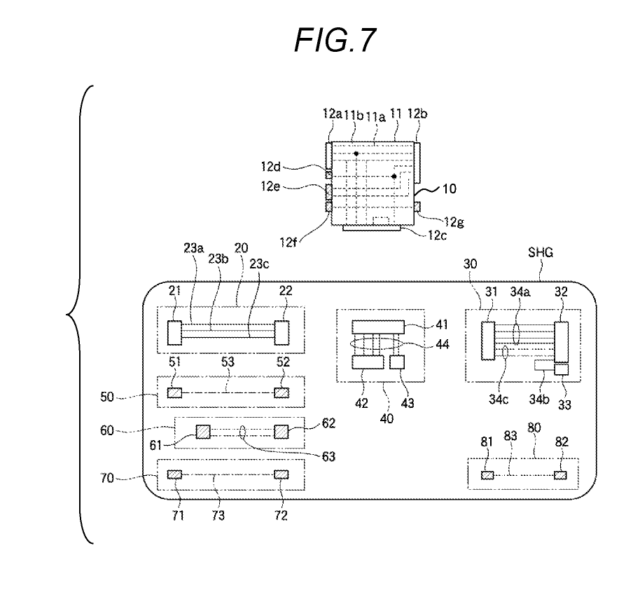

FIG. 6 illustrates an example of the entire configuration of a wiring harness 100 in a first example of the second embodiment. FIG. 7 illustrates each configuration element which is prepared in advance to form the wiring harness 100 illustrated in FIG. 6. In FIGS. 6 and 7, for easy understanding of the configuration, each electrical cable is illustrated as being shorter than an actual length. It is assumed that electrical cables of suitable lengths in a range of 10 [cm] to several hundreds [cm] are actually used as necessary in the wiring harness 100. A wiring harness or sub-harness illustrated in FIG. 6 includes standard circuits (illustrated by solid lines in FIG. 6, and hereinafter, may be referred to as standard circuit cables) which are inevitably used regardless of the type, grade, or option of a vehicle, and circuits (illustrated by alternating long and short dash lines in FIG. 6, and hereinafter, may be referred to as selective circuit cables) which are selectively added according to the vehicle type, the grade, or the option.

The wiring harness 100 illustrated in FIG. 6 is formed of a combination of one connection unit 10, three standard sub-harnesses 20, 30, and 40, and four optional sub-harnesses 50, 60, 70, and 80.

Specifically, a connector 22 connected to a first end of the standard sub-harness 20 prepared in advance is connected to a substrate side connector 12a of the connection unit 10. A connector 31 connected to a first end of the standard sub-harness 30 prepared in advance is connected to a substrate side connector 12b of the connection unit 10. A connector 41 connected to a first end of the standard sub-harness 40 prepared in advance is connected to a substrate side connector 12c of the connection unit 10. A connector 52 of the optional sub-harness 50 is connected to a substrate side connector 12d of the connection unit 10. A connector 62 of the optional sub-harness 60 is connected to a substrate side connector 12e of the connection unit 10. A connector 72 of the optional sub-harness 70 is connected to a substrate side connector 12f of the connection unit 10. A connector 81 of the optional sub-harness 80 is connected to a substrate side connector 12g of the connection unit 10.

That is, all end portions of the three standard sub-harnesses 20 to 40 and the four optional sub-harnesses 50 to 80 are physically connected to the connection unit 10. Accordingly, electrical cables of the standard sub-harnesses 20 to 40 and the optional sub-harnesses 50 to 80 can be electrically connected to each other via a circuit pattern (to be described later) provided in the connection unit 10.

The wiring harness 100 illustrated in FIG. 6 includes the connection unit 10; the three standard sub-harnesses 20 to 40; and the four optional sub-harnesses 50 to 80. The four optional sub-harnesses 50 to 80 are selectively connected to the connection unit 10. That is, the four optional sub-harnesses 50 to 80 are selectively connected to the connection unit 10 according to the required wiring harness specifications corresponding to the type, grade, or existence and non-existence of various options of a vehicle in which the wiring harness 100 is mounted, and as a result, the wiring harness 100 illustrated in FIG. 6 which is suitable for the specifications is formed.

<Description of Each Configuration Element>

<Description of Connection Unit 10>

The connection unit 10 illustrated in FIG. 7 includes a circuit substrate 11 that is formed of a thin plate and has a rectangular planar shape, and multiple substrate side connectors 12a to 12g which are mounted on the circuit substrate 11. Specifically, the circuit substrate 11 is formed of a printed substrate including an electrical insulating substrate 11b and a circuit pattern 11a formed on this substrate. In a case where the circuit pattern 11a having a relative complex configuration is formed, the circuit substrate 11 is formed of a multi-layer printed substrate.

The circuit pattern 11a is formed of a foil-shaped conductive pattern such as a copper foil sticking to a front surface or a rear surface of the electrical insulating substrate 11b, or boundary surfaces between layers in a thickness direction. As illustrated by dotted lines in FIG. 7, the circuit pattern 11a includes many wirings through which the substrate side connectors 12a to 12g are connected to each other. Many wirings are electrically separated from each other, and portions of the wirings are electrically connected to each other. In a case where multiple wirings are required to be electrically separated from each other at intersecting locations on a plane illustrated in FIG. 7, the wirings are disposed on different surfaces or layers. In a case where wirings disposed on different surfaces or layers are required to be connected to each other, electrical connection therebetween is realized via through holes passing through the electrical insulating substrate 11b in the thickness direction.

The connection unit 10 illustrated in FIG. 7 includes the substrate side connectors 12a to 12g which enable easy connection and disconnection between the standard sub-harnesses 20 to 40 and the optional sub-harnesses 50 to 80.

In order to protect the connection unit 10, or to prevent electrical contact between the circuit pattern 11a and peripheral circuits, it is also considered that the connection unit 10 is configured to be accommodated in a suitable housing. The connection unit 10 may be configured such that the periphery of the connection unit 10 is covered with electrical insulating resin or the like.

<Description of Standard Sub-Harness>

The standard sub-harness 20 illustrated in FIG. 7 includes three electrical cables 23a, 23b, and 23c, and connectors 21 and 22 that are connected to both end portions thereof. As a specific example, it is assumed that the electrical cable 23a is used as an electricity supply cable for supplying electricity, the electrical cable 23b is used as a ground cable, and the electrical cable 23c is used as a signal cable or a communication cable.

Each of the electrical cables 23a, 23b, and 23c is configured such that the periphery of a conductor such as a stranded wire is coated with electrical insulating resin or the like. The thickness of the conductor or the thickness and material of the coating of each of the electrical cables 23a, 23b, and 23c is suitably determined according to a current value or a voltage value which changes according to specifications. In the example illustrated in FIG. 7, the three electrical cables 23a, 23b, and 23c are assumed to be standard electrical cables which are mounted in all vehicles. Accordingly, there is one type of standard sub-harness 20.

The standard sub-harness 40 illustrated in FIG. 7 includes an electrical cable group 44 formed of six electrical cables, and three connectors 41, 42, and 43 that are connected to end portions thereof. The six electrical cables of the electrical cable group 44 are assumed to be standard electrical cables which are mounted in all the vehicles. Accordingly, there is one type of standard sub-harness 40.

Each of the six electrical cables of the electrical cable group 44 is used as an electricity supply cable, a ground cable, a signal cable, a communication cable, or the like.

The standard sub-harness 30 illustrated in FIG. 7 includes an electrical cable group 34a; an electrical cable 34b; an electrical cable group 34c; the connector 31; and connectors 32 and 33. The electrical cable group 34a is formed of four electrical cables, and the electrical cable group 34c is formed of two electrical cables.

In the standard sub-harness 30 illustrated in FIG. 7, the electrical cable groups 34a and 34b are standard electrical cables which are mounted in all the vehicles, and the electrical cable group 34c is selectively used according to the required specifications of the wiring harness 100, that is, according to the type, grade, or existence and non-existence of various options of a vehicle. Accordingly, there is a possibility that two or more types (part numbers) of standard sub-harness 30 have to be prepared in advance.

<Description of Optional Sub-Harness>

The optional sub-harness 50 illustrated in FIG. 7 includes an electrical cable 53 and two connectors 51 and 52 that are connected to both end portions thereof. The length of the electrical cable 53, the shape of the connector 51, and the like are determined according to specifications of the optional sub-harness 50.

The optional sub-harness 60 illustrated in FIG. 7 includes an electrical cable group 63 and two connectors 61 and 62 that are connected to both end portions thereof. The electrical cable group 63 is formed of two electrical cables. The length of the electrical cable group 63, the shape of the connector 61, and the like are determined according to specifications of the optional sub-harness 60.

The optional sub-harness 70 illustrated in FIG. 7 includes an electrical cable 73 and two connectors 71 and 72 that are connected to both end portions thereof. The length of the electrical cable 73, the shape of the connector 71, and the like are determined according to specifications of the optional sub-harness 70.

The optional sub-harness 80 illustrated in FIG. 7 includes an electrical cable 83 and two connectors 81 and 82 that are connected to both end portions thereof. The length of the electrical cable 83, the shape of the connector 82, and the like are determined according to specifications of the optional sub-harness 80.

Basically, there is one type of each of the optional sub-harnesses 50, 60, 70, and 80; however, as necessary, two or more types of each of the optional sub-harnesses 50, 60, 70, and 80 may be prepared.

<Advantages of Wiring Harness 100 of First Example of Second Embodiment>

Each of various sub-harnesses of a wiring harness in the related art includes various standard circuit cables which are common to all vehicles, and various optional circuit cables which are selectively added according to a vehicle type, a grade, or the existence and non-existence of various options. For this reason, the number of part numbers of sub-harnesses which have to be prepared exponentially increases to the extent that the number of selective circuit cables provided in a wiring harness increases. In contrast, in the wiring harness 100 illustrated in FIG. 6, as illustrated in FIG. 7, the standard sub-harnesses 20 to 40 formed of standard circuit cables are sub-harnesses different from the optional sub-harnesses 50 to 80 formed of selective circuit cables. In a case where sub-harnesses are formed in this manner, even if the number of selective circuit cables increases by n, the number of part numbers of the sub-harnesses increases by n. As such, it is possible to prevent a significant increase in the number of part numbers of sub-harnesses in comparison with an increase in the number of part numbers of sub-harnesses in the related art.

In the wiring harness 100 illustrated in FIG. 6, the circuit substrate 11 of the connection unit 10 serves to connect together the circuit cables of the sub-harnesses. That is, the connection pattern of the circuit cables is determined by the circuit substrate 11. For this reason, it is not necessary to provide branch cables in each sub-harness, and thus, the shape of each sub-harness without branch cables becomes simple. As a result, it is possible to manufacture sub-harnesses at cheaper prices. In contrast, a circuit pattern for connecting together all the circuit cables is required to be provided on the circuit substrate 11. Even if the maximum total number of circuit cables is estimated, the price of the circuit substrate 11 is not high. As a result, the entire configuration of a wiring harness becomes simplified, and thus, it is possible to provide a wiring harness at a cheaper price.

Since the shapes of the sub-harnesses become simplified which include a small number of branch cables, it is possible to increase similarity between the shapes of multiple sub-harnesses. This means that the sub-harnesses have high versatilities. As a result, a sub-harness can be used in common, for example, a sub-harness can be used in a wiring harness at multiple locations, or a sub-harness used in a wiring harness can be used in a separate wiring harness. This means that a common sub-harness can be used in various wiring harnesses.

The reason a sub-harness can be used in common as described above is that the circuit substrate 11 serves to connect together circuit cables. The circuit substrate 11 has not only a so-called joint function for connecting together circuit cables, but also a rectification function for adjusting a connection relationship in which multiple circuit cables which have to be connected together are selected. If circuit substrates having different circuit patterns are prepared, it is possible to arbitrarily switch a connection relationship between circuit cables.

This means that the required specifications of a wiring harness is switched by a circuit pattern of a circuit substrate. A sub-harness can be used in common, and since specification change functions are consolidated into a circuit substrate, a wiring harness can be used in common in various grades and options of vehicles, and a wiring harness can be used in common in various vehicle types. A wiring harness in the related art is designed for each vehicle type, and in contrast, the designing of the wiring harness 100 illustrated in FIG. 6 can be performed without being constrained by a framework called a vehicle type.

Hereinafter, advantages of the wiring harness 100 in terms of operation efficiency in the manufacturing of a wiring harness will be ascertained. Each of the multiple standard sub-harnesses 20 to 40 of the wiring harness 100 is realized by connecting together two electrical cables, one of which forms the sub-harness (A1, A2, or B2 in FIG. 11) in the related art. For this reason, the electrical cable length of each of the standard sub-harnesses 20 to 40 is shorter than that of the sub-harness in the related art. This means that the length of one electrical cable along a routing path when an operator routes a sub-harness on a jig plate is short. If the length of an electrical cable is long, an operator has to move further by that extent. A short length of an electrical cable contributes to an improvement in efficiency of an operation of routing a sub-harness.

### Second Example of Second Embodiment

### Entire Configuration of Wiring Harness

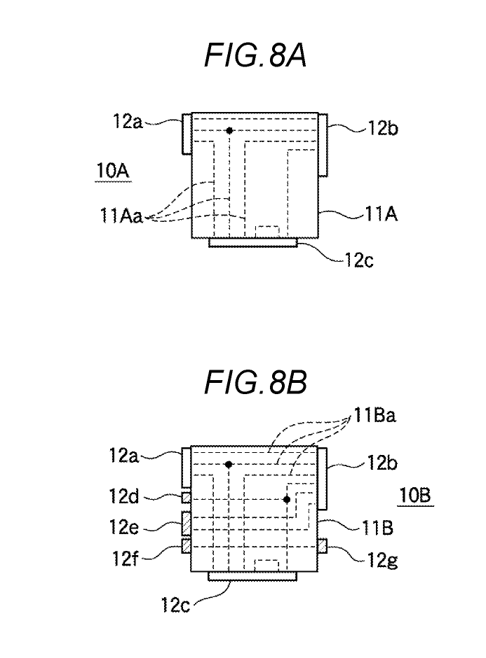

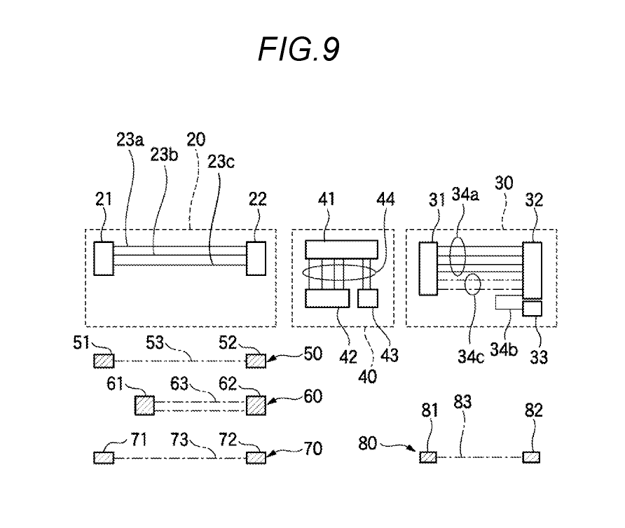

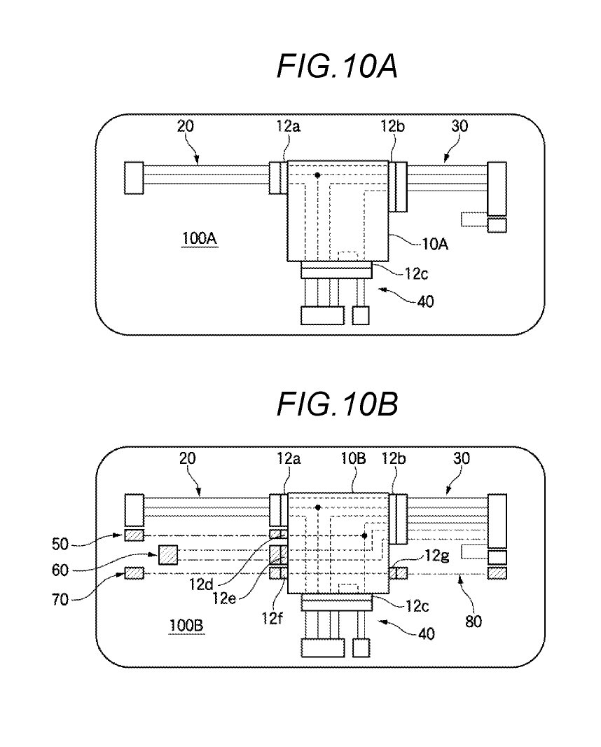

FIGS. 8A and 8B illustrate the configurations of two types of connection units which can be used to form a wiring harness in a second example of the second embodiment. FIG. 9 illustrates the configuration of each sub-harness group that can be used to form the wiring harness in the second example of the second embodiment. FIGS. 10A and 10B illustrate examples of the configurations of two types of wiring harness in the second example of the second embodiment. In FIGS. 8 to 10, for easy understanding of the configuration, each electrical cable is illustrated as being shorter than an actual length. It is assumed that electrical cables of suitable lengths in a range of 10 [cm] to several hundreds [cm] are used as necessary in an actual wiring harness.

A wiring harness 100A illustrated in FIG. 10A is formed of a combination of one connection unit 10A and three standard sub-harnesses 20, 30, and 40. A wiring harness 100B illustrated in FIG. 10B is formed of a combination of one connection unit 10B, the three standard sub-harnesses 20, 30, and 40, and four optional sub-harnesses 50, 60, 70, and 80.

The connection unit 10A is selectively used to form the wiring harness 100A, and the connection unit 10B is selectively used to form the wiring harness 100B. The connection unit 10A illustrated in FIG. 8A and the connection unit 10B illustrated in FIG. 8B respectively adopt circuit substrates 11A and 11B, the circuit patterns of which are different from each other.

Specifically, a connector 22 connected to a first end of the standard sub-harness 20 prepared in advance is connected to a substrate side connector 12a of the connection unit 10A or 10B. A connector 31 connected to a first end of the standard sub-harness 30 prepared in advance is connected to a substrate side connector 12b of the connection unit 10A or 10B. A connector 41 connected to a first end of the standard sub-harness 40 prepared in advance is connected to a substrate side connector 12c of the connection unit 10A or 10B. A connector 52 of the optional sub-harness 50 is connected to a substrate side connector 12d of the connection unit 10B. A connector 62 of the optional sub-harness 60 is connected to a substrate side connector 12e of the connection unit 10. A connector of the optional sub-harness 70 is connected to a substrate side connector 12f of the connection unit 10. A connector 81 of the optional sub-harness 80 is connected to a substrate side connector 12g of the connection unit 10.

That is, all end portions of the three standard sub-harnesses 20 to 40 of the wiring harness 100A are physically connected to the connection unit 10A. All end portions of the three standard sub-harnesses 20 to 40 and the four optional sub-harnesses 50 to 80 of the wiring harness 100B are physically connected to the connection unit 10B. Accordingly, electrical cables of the standard sub-harnesses 20 to 40 and the optional sub-harnesses 50 to 80 can be electrically connected to each other via a circuit pattern (to be described later) provided in the connection unit 10A or 10B.

The wiring harness 100 illustrated in FIG. 6 includes the connection unit 10; the three standard sub-harnesses 20 to 40; and the four optional sub-harnesses 50 to 80. The four optional sub-harnesses 50 to 80 are selectively connected to the connection unit 10. In a case where the optional sub-harnesses 50 to 80 are not connected, the connection unit 10A is selectively used. In a case where the optional sub-harnesses 50 to 80 are connected, the connection unit 10B is selectively used.

That is, a difference between connection patterns of circuit cables caused by a change in wiring harness specifications changing according to the type, grade, or existence and non-existence of various options of a vehicle in which a wiring harness is mounted is absorbed by a difference between the circuit patterns of the connection units 10A and 10B. The four optional sub-harnesses 50 to 80 are selectively connected to the connection unit 10B, and as a result, the wiring harness 100A or 100B illustrated in FIG. 10A or 10B which is suitable for the specifications is formed.

<Description of Each Configuration Element>

<Description of Connection Units 10A and 10B>

The connection unit 10A illustrated in FIG. 8A includes a circuit substrate 11A that is formed of a thin plate and has a rectangular planar shape, and multiple substrate side connectors 12a to 12c which are mounted on the circuit substrate 11A. Specifically, the circuit substrate 11A is formed of a printed substrate including an electrical insulating substrate 11b and a circuit pattern 11a formed on this substrate. In a case where the circuit pattern 11a having a relative complex configuration is formed, the circuit substrate 11 is formed of a multi-layer printed substrate.

The connection unit 10B illustrated in FIG. 8B includes a circuit substrate 11B and multiple substrate side connectors 12a to 12g which are mounted on the circuit substrate 11B. Only a difference between the circuit substrate 11A and the circuit substrate 11B is a difference between circuit patterns 11Aa and 11Ba which are respectively formed thereon.

Each of the circuit patterns 11Aa and 11Ba is formed of a foil-shaped conductive pattern such as a copper foil sticking to a front surface or a rear surface of the electrical insulating substrate 11b, or boundary surfaces between layers in a thickness direction. As illustrated by dotted lines in FIGS. 8A and 8B, each of the circuit patterns 11Aa and 11Ba includes many wirings through which the substrate side connectors 12a to 12g are connected to each other. As illustrated in FIGS. 8A and 8B, the circuit patterns 11Aa and 11Ba are different from each other. That is, the circuit pattern 11Aa is configured such that connection between the circuit cables is realized according the specifications of the wiring harness 100A illustrated in FIG. 10A. The circuit pattern 11Ba is configured such that connection between the circuit cables is realized according to the specifications of the wiring harness 100B illustrated in FIG. 10B.

Many wirings in each of the circuit patterns 11Aa and 11Ba are electrically separated from each other, and portions of the wirings are electrically connected to each other. In a case where multiple wirings are required to be electrically separated from each other at intersecting locations on a plane illustrated in FIG. 8A or 8B, the wirings are disposed on different surfaces or layers such that the wirings are electrically separated from each other. In a case where wirings disposed on different surfaces or layers are required to be connected to each other, electrical connection therebetween is realized via through holes passing through the electrical insulating substrate 11b in the thickness direction.

The connection units 10A and 10B illustrated in FIGS. 8A and 8B include the substrate side connectors 12a to 12g which enable easy connection and disconnection between the standard sub-harnesses 20 to 40 and the optional sub-harnesses 50 to 80.

In order to protect the connection units 10A and 10B, or to prevent electrical contact between the circuit patterns 11Aa and 11Ba and peripheral circuits, it is also considered that the connection units 10A and 10B are configured to be respectively accommodated in suitable housings. The connection units may be configured such that the peripheries of the connection units are covered with electrical insulating resin or the like.

<Description of Standard Sub-Harness>

The standard sub-harness 20 illustrated in FIG. 9 includes three electrical cables 23a, 23b, and 23c, and connectors 21 and 22 that are connected to both end portions thereof. As a specific example, it is assumed that the electrical cable 23a is used as an electricity supply cable for supplying electricity, the electrical cable 23b is used as a ground cable, and the electrical cable 23c is used as a signal cable or a communication cable.

Each of the electrical cables 23a, 23b, and 23c is configured such that the periphery of a conductor such as a stranded wire is coated with electrical insulating resin or the like. The thickness of the conductor or the thickness and material of the coating of each of the electrical cables 23a, 23b, and 23c is suitably determined according to a current value or a voltage value which changes according to specifications. In the example illustrated in FIG. 9, the three electrical cables 23a, 23b, and 23c are assumed to be standard electrical cables which are mounted in all vehicles. Accordingly, there is one type of standard sub-harness 20.

The standard sub-harness 40 illustrated in FIG. 9 includes an electrical cable group 44 formed of six electrical cables, and three connectors 41, 42, and 43 that are connected to end portions thereof. The six electrical cables of the electrical cable group 44 are assumed to be standard electrical cables which are mounted in all the vehicles. Accordingly, there is one type of standard sub-harness 40.

Each of the six electrical cables of the electrical cable group 44 is used as an electricity supply cable, a ground cable, a signal cable, a communication cable, or the like.

The standard sub-harness 30 illustrated in FIG. 9 includes an electrical cable group 34a; an electrical cable 34b; an electrical cable group 34c; the connector 31; and connectors 32 and 33. The electrical cable group 34a is formed of four electrical cables, and the electrical cable group 34c is formed of two electrical cables.

In the standard sub-harness 30 illustrated in FIG. 9, the electrical cable groups 34a and 34b are standard electrical cables which are mounted in all the vehicles, and the electrical cable group 34c is selectively used according to the required specifications of the wiring harness 100, that is, according to the type, grade, or existence and non-existence of various options of a vehicle. Accordingly, there is a possibility that two or more types (part numbers) of standard sub-harness 30 have to be prepared in advance.

<Description of Optional Sub-Harness>

The optional sub-harness 50 illustrated in FIG. 9 includes an electrical cable 53 and two connectors 51 and 52 that are connected to both end portions thereof. The length of the electrical cable 53, the shape of the connector 51, and the like are determined according to specifications of the optional sub-harness 50.

The optional sub-harness 60 illustrated in FIG. 9 includes an electrical cable group 63 and two connectors 61 and 62 that are connected to both end portions thereof. The electrical cable group 63 is formed of two electrical cables. The length of the electrical cable group 63, the shape of the connector 61, and the like are determined according to specifications of the optional sub-harness 60.

The optional sub-harness 70 illustrated in FIG. 9 includes an electrical cable 73 and two connectors 71 and 72 that are connected to both end portions thereof. The length of the electrical cable 73, the shape of the connector 71, and the like are determined according to specifications of the optional sub-harness 70.

The optional sub-harness 80 illustrated in FIG. 9 includes an electrical cable 83 and two connectors 81 and 82 that are connected to both end portions thereof. The length of the electrical cable 83, the shape of the connector 82, and the like are determined according to specifications of the optional sub-harness 80.

Basically, there is one type of each of the optional sub-harnesses 50, 60, 70, and 80; however, as necessary, two or more types of each of the optional sub-harnesses 50, 60, 70, and 80 may be prepared. For example, since there may be a significant difference between distances among electrical components, it is necessary to prepare the optional sub-harnesses 50 to 80 having different lengths in advance so as to form the wiring harness 100 that is mounted in multiple types of vehicles having vehicle bodies of significantly different sizes.

<Advantages of Wiring Harnesses 100A and 100B of Second Example of Second Embodiment>

In a case where the wiring harnesses 100A and 100B illustrated in FIGS. 10A and 10B are formed, it is possible to change the state of electrical connection between multiple sub-harnesses merely by replacing the circuit patterns 11Aa and 11Ba of the circuit substrates 11A and 11B, which are portions of the wiring harnesses, with each other. For example, in a case where the circuit substrate 11B illustrated in FIG. 8B is selected, as in the wiring harness 100B illustrated in FIG. 10B, the circuit cables of the optional sub-harnesses 50, 60, and 70 can be connected to the circuit cable of the standard sub-harness 30, and the circuit cables of the optional sub-harness 50 can be connected to the circuit cables of the standard sub-harness 40. In a case where the circuit substrate 11A illustrated in FIG. 8A is selected, only the circuit cables of the standard sub-harnesses 20, 30, and 40 can be connected together.

Accordingly, it is possible to form various specifications of wiring harnesses using multiple sub-harnesses of a relatively small number of types or the numbers of part numbers in common. That is, since it is possible to use a sub-harness with the same configuration in multiple specifications of wiring harnesses, it is possible to considerably reduce the number of types or part numbers of sub-harnesses which have to be prepared in advance.

The aforementioned characteristics of the wiring harness according to the second embodiment are briefly summarized and listed in [1] to [5].

[1] A wiring harness (100) includes a first sub-harness (standard sub-harness 20) including first circuit cables (electrical cables 23a, 23b, and 23c); a second sub-harness (standard sub-harness 30) including second circuit cables (electrical cables 34a, 34b, and 34c); and a circuit substrate (11) on which a circuit pattern (11a), which can be connected to the first sub-harness and the second sub-harness, is formed. When the first sub-harness and the second sub-harness are connected to the circuit substrate, the first circuit cables and the second circuit cables are conductively connected together via the circuit pattern.

[2] In the wiring harness with the configuration described in [1], the circuit substrate includes a plurality of connection portions (substrate side connectors 12a to 12g) which can be attachably and detachably connected to end portions of a plurality of sub-harnesses including the first sub-harness and the second sub-harness.

[3] In the wiring harness with the configuration described in [1], the circuit pattern is formed on the circuit substrate so as to correspond to different types of the plurality of sub-harnesses including the first sub-harness and the second sub-harness which are connected according to required specifications.

[4] In the wiring harness with the configuration described in any one of [1] to [3], the circuit substrate is a printed substrate that includes an electrical insulating substrate and a foil-shaped conductive pattern sticking to at least one surface of the substrate.

[5] In the wiring harness with the configuration described in [4], the circuit substrate is a multi-layer printed substrate which includes multiple electrical insulating layers that are disposed while being superimposed on top of each other in a thickness direction, and in which the multiple foil-shaped patterns electrically separated from each other are respectively formed at the boundaries and on front surfaces of the multiple electrical insulating layers.

### Third Embodiment

The wiring harness routing structure of the first embodiment of the present invention can be applied to a wiring harness to be described below. Hereinafter, a wiring harness of a third embodiment of the present invention will be described.

### BACKGROUND OF THE INVENTION

Field of the Invention

The third embodiment of the present invention relates to a wiring harness that is formed of multiple sub-harnesses.

Description of Related Art

Patent Literature 2 and Patent Literature 3 disclose the related art relating to a wiring harness used in a vehicle. As illustrated in FIG. 1 of Patent Literature 2, typically, such a wiring harness is an aggregate of bundled multiple sub-harnesses which are respectively prepared for systems. Sub-harnesses to be bundled together differ according to the required specifications of the wiring harness.

Specifically, the required electrical components of a vehicle differ according to the type, grade, or required options of the vehicle. For this reason, circuit cables of an electricity supply cable, a ground cable, a signal cable, and a communication cable, which are connected to each electrical component, differ. A sub-harness represents a set of circuit cables for driving an electrical system which are bundled together according to electrical systems so as to cope with such a difference between the circuit cables. One wiring harness is formed by selecting sub-harnesses according to the required specifications corresponding to a vehicle type, a grade, or an option, and by bundling together the sub-harnesses.

### [Patent Literature 2] JP-A-2001-160464

### [Patent Literature 3] JP-A-2001-169433

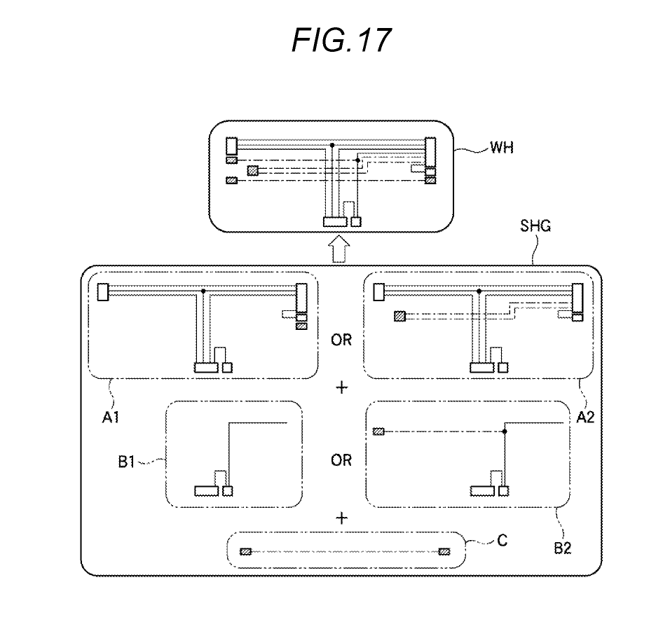

FIG. 17 illustrates a relationship between an example of a specific configuration of a wiring harness WH and multiple types of sub-harnesses which are prepared in advance so as to form the wiring harness. Hereinafter, the example of the configuration of the wiring harness illustrated in FIG. 17 will be described.

In FIG. 17, sub-harnesses A1, A2, B1, B2, and C which form a sub-harness group SHG are prepared. Accordingly, the wiring harness WH can be formed by bundling together multiple sub-harnesses which are suitably selected from the sub-harness group SHG.

For example, the wiring harness WH can be formed as an assembly in which three sub-harnesses, that is, the sub-harness A2, the sub-harness B2, and the sub-harness C illustrated in FIG. 17, are combined together. It is necessary to change the configuration of the wiring harness WH so as to correspond to a difference between specifications such as the type, grade, and option of a vehicle in which the wiring harness WH is mounted. That is, the number of electrical cables, the existence and non-existence of connectors connected to each electrical cable, or the like of the wiring harness WH is suitably changed.

In the example illustrated in FIG. 17, it is possible to change the entire configuration of the wiring harness WH by changing a combination of sub-harnesses selected from the sub-harness group SHG as follows.

(1) The wiring harness WH is formed of a combination of three sub-harnesses, that is, the sub-harness A1, the sub-harness B1, and the sub-harness C.

(2) The wiring harness WH is formed of a combination of three sub-harnesses, that is, the sub-harness A2, the sub-harness B1, and the sub-harness C.

(3) The wiring harness WH is formed of a combination of three sub-harnesses, that is, the sub-harness A1, the sub-harness B2, and the sub-harness C.

(4) The wiring harness WH is formed of a combination of two sub-harnesses, that is, the sub-harness A1 and the sub-harness B1.

(5) The wiring harness WH is formed of a combination of two sub-harnesses, that is, the sub-harness A2 and the sub-harness B1.

(6) The wiring harness WH is formed of a combination of two sub-harnesses, that is, the sub-harness A1 and the sub-harness B2.

As such, a wiring harness corresponds to specifications which differ according to a vehicle type, a grade, or an option. As illustrated in FIG. 1 of Patent Literature 2, such a wiring harness is routed in a reinforcement. There is a wiring harness referred to as an instrument panel wiring harness.

The aforementioned current wiring harness or sub-harness includes standard circuits (illustrated by solid lines in FIG. 17, and hereinafter, may be referred to as standard circuit cables) which are inevitably used regardless of the type, grade, or option of a vehicle, and circuits (illustrated by alternating long and short dash lines in FIG. 17, and hereinafter, may be referred to as selective circuit cables) which are selectively added according to the vehicle type, the grade, or the option.

More sub-harnesses having different part numbers have to be prepared to the extent that the number of circuits selectively added to a sub-harness increases. Since the sub-harnesses A1 and A2 of the sub-harness group SHG illustrated in FIG. 17 include only one selectively added circuit, two types of sub-harnesses (A1 and A2) may be prepared. In contrast, if there are two selectively added circuits, four types of sub-harnesses are required. If there are three selectively added circuits, eight types of sub-harnesses are required. That is, the types (part numbers) of sub-harnesses which have to be prepared in advance exponentially increase.

In a case where a sub-harness is formed of a combination of standard circuit cables and selective circuit cables, the number of sub-harnesses which have to be managed tends to increase as the number of electrical components increases, or the number of vehicle types, the number of grades, or the number of options increases.

The third embodiment is made in light of the aforementioned problem, and an object of the present invention is to provide a wiring harness in which it is possible to prevent an increase in the number of part numbers of sub-harnesses which have to be prepared in advance.

### SUMMARY

One or more embodiments provide a wiring harness according to the third embodiment has the following characteristics in (1) to (5).

In an aspect (1), one or more embodiments a wiring harness including a first sub-harness including first circuit cables a second sub-harness including second circuit cables a third sub-harness including third circuit cables; and a circuit substrate on which a circuit pattern, which can be connected to at least two of the first sub-harness, the second sub-harness, and the third sub-harness, is formed. A first circuit substrate and a second circuit substrate on which different circuit patterns are respectively formed are prepared as the circuit substrates. In a case where the first sub-harness and the second sub-harness are connected to the first circuit substrate, the first circuit cables and the second circuit cables are conductively connected together via the circuit pattern on the first circuit substrate. In a case where the first sub-harness and the third sub-harness are connected to the second circuit substrate, the first circuit cables and the third circuit cables are conductively connected together via the circuit pattern on the second circuit substrate.

In an aspect (2), the wiring harness further includes a fourth sub-harness including fourth circuit cables, in which in a case where the third sub-harness and the fourth sub-harness are connected to the second circuit substrate, the third circuit cables and the fourth circuit cables are conductively connected together via the circuit pattern on the second circuit substrate.

In an aspect (3), each of the first circuit substrate and the second circuit substrate includes multiple connection portions which are attachably and detachably connected to at least two of the first sub-harness, the second sub-harness, and the third sub-harness.

In an aspect (4), the circuit substrate is a printed substrate that includes an electrical insulating substrate and a foil-shaped conductive pattern sticking to at least one surface of the substrate.

In an aspect (5), the circuit substrate is a multi-layer printed substrate which includes multiple electrical insulating layers that are disposed while being superimposed on top of each other in a thickness direction, and in which the multiple foil-shaped patterns electrically separated from each other are respectively formed at the boundaries and on front surfaces of the multiple electrical insulating layers.

According to the aspect (1), it is possible to realize a wiring harness suitable for desired specifications by selecting a suitable circuit substrate from the first circuit substrate and the second circuit substrate, and by combining together the circuit substrate and at least two of the first sub-harness, the second sub-harness, and the third sub-harness. That is, it is possible to easily cope with requirements according to specifications via replacement of the circuit substrate.

According to the aspect (2), in a case where the second circuit substrate is selected, the third circuit cables and the fourth circuit cables can be connected together via the circuit pattern on the second circuit substrate. As a result, it is possible to easily form various types of wiring harnesses.

According to the aspect (3), the first sub-harness, the second sub-harness, and the third sub-harness are connected to the first circuit substrate or the second circuit substrate via the connection portions, and thus, the attachment and detachment of connection locations is easy, and the replacement of the circuit substrate is easy. According to the aspect (4), it is possible to easily realize the circuit pattern through which the first circuit cables of the first sub-harness are connected to the second circuit cables of the second sub-harness, and the circuit pattern through which the first circuit cables of the first sub-harness are connected to the third circuit cables of the third sub-harness.

According to the aspect (5), insulating states of multiple independent circuit cables can be maintained at locations where the circuit cables intersect each other. As a result, it is possible to form a circuit pattern with a complex configuration, and it is possible to cope with an increase in the number of electrical cables of a wiring harness.

According to the wiring harness of the third embodiment of the present invention, it is possible to prevent an increase in the number of part numbers of sub-harnesses which have to be prepared in advance. That is, since it is possible to switch the existence and non-existence of connection between the first circuit cables and the second circuit cables, and the connection states of branch cables of the circuit cables via the circuit pattern inside the circuit substrate, even if various types of connection states are required in the entirety of the wiring harness, it is possible to simplify the configuration of each of the first sub-harness and the second sub-harness. In a case where a wiring harness is formed to connect a long distance path in its entirety, it is possible to use the first sub-harness and the second sub-harness of relatively short lengths.

According to the wiring harness, it is possible to realize a wiring harness suitable for desired specifications by selecting a suitable circuit substrate from the first circuit substrate and the second circuit substrate, and by combining together the circuit substrate and at least two of the first sub-harness, the second sub-harness, and the third sub-harness. That is, it is possible to easily cope with requirements according to specifications via replacement of the circuit substrate.

The present invention has been briefly described. If a form (hereinafter, referred to as an “embodiment”) for realizing the invention which will be described below is read through with the accompanying drawings, details of the present invention become further apparent.

### BRIEF DESCRIPTION OF THE DRAWINGS

Hereinafter, wiring harnesses of the third embodiment of the present invention will be specifically described with reference to the drawings.

### First Example of Third Embodiment

### Entire Configuration of Wiring Harness 100

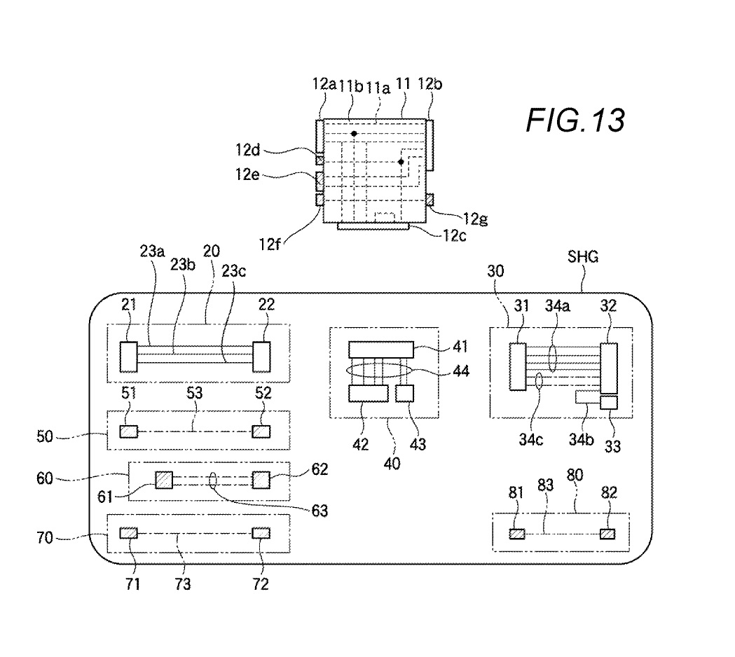

FIG. 12 illustrates an example of the entire configuration of a wiring harness 100 in a first example of the third embodiment. FIG. 13 illustrates each configuration element which is prepared in advance to form the wiring harness 100 illustrated in FIG. 12. In FIGS. 12 and 13, for easy understanding of the configuration, each electrical cable is illustrated as being shorter than an actual length. It is assumed that electrical cables of suitable lengths in a range of 10 [cm] to several hundreds [cm] are actually used as necessary in the wiring harness 100. A wiring harness or sub-harness illustrated in FIG. 12 includes standard circuits (illustrated by solid lines in FIG. 12, and hereinafter, may be referred to as standard circuit cables) which are inevitably used regardless of the type, grade, or option of a vehicle, and circuits (illustrated by alternating long and short dash lines in FIG. 12, and hereinafter, may be referred to as selective circuit cables) which are selectively added according to the vehicle type, the grade, or the option.

The wiring harness 100 illustrated in FIG. 12 is formed of a combination of one connection unit 10, three standard sub-harnesses 20, 30, and 40, and four optional sub-harnesses 50, 60, 70, and 80.

Specifically, a connector 22 connected to a first end of the standard sub-harness 20 prepared in advance is connected to a substrate side connector 12a of the connection unit 10. A connector 31 connected to a first end of the standard sub-harness 30 prepared in advance is connected to a substrate side connector 12b of the connection unit 10. A connector 41 connected to a first end of the standard sub-harness 40 prepared in advance is connected to a substrate side connector 12c of the connection unit 10. A connector 52 of the optional sub-harness 50 is connected to a substrate side connector 12d of the connection unit 10. A connector 62 of the optional sub-harness 60 is connected to a substrate side connector 12e of the connection unit 10. A connector 72 of the optional sub-harness 70 is connected to a substrate side connector 12f of the connection unit 10. A connector 81 of the optional sub-harness 80 is connected to a substrate side connector 12g of the connection unit 10.

That is, all end portions of the three standard sub-harnesses 20 to 40 and the four optional sub-harnesses 50 to 80 are physically connected to the connection unit 10. Accordingly, electrical cables of the standard sub-harnesses 20 to 40 and the optional sub-harnesses 50 to 80 can be electrically connected to each other via a circuit pattern (to be described later) provided in the connection unit 10.

The wiring harness 100 illustrated in FIG. 12 includes the connection unit 10; the three standard sub-harnesses 20 to 40; and the four optional sub-harnesses 50 to 80. The four optional sub-harnesses 50 to 80 are selectively connected to the connection unit 10. That is, the four optional sub-harnesses 50 to 80 are selectively connected to the connection unit 10 according to the required wiring harness specifications corresponding to the type, grade, or existence and non-existence of various options of a vehicle in which the wiring harness 100 is mounted, and as a result, the wiring harness 100 illustrated in FIG. 12 which is suitable for the specifications is formed.

<Description of Each Configuration Element>

<Description of Connection Unit 10>

The connection unit 10 illustrated in FIG. 13 includes a circuit substrate 11 that is formed of a thin plate and has a rectangular planar shape, and multiple substrate side connectors 12a to 12g which are mounted on the circuit substrate 11. Specifically, the circuit substrate 11 is formed of a printed substrate including an electrical insulating substrate 11b and a circuit pattern 11a formed on this substrate. In a case where the circuit pattern 11a having a relative complex configuration is formed, the circuit substrate 11 is formed of a multi-layer printed substrate.

The circuit pattern 11a is formed of a foil-shaped conductive pattern such as a copper foil sticking to a front surface or a rear surface of the electrical insulating substrate 11b, or boundary surfaces between layers in a thickness direction. As illustrated by dotted lines in FIG. 13, the circuit pattern 11a includes many wirings through which the substrate side connectors 12a to 12g are connected to each other. Many wirings are electrically separated from each other, and portions of the wirings are electrically connected to each other. In a case where multiple wirings are required to be electrically separated from each other at intersecting locations on a plane illustrated in FIG. 13, the wirings are disposed on different surfaces or layers. In a case where wirings disposed on different surfaces or layers are required to be connected to each other, electrical connection therebetween is realized via through holes passing through the electrical insulating substrate 11b in the thickness direction.

The connection unit 10 illustrated in FIG. 13 includes the substrate side connectors 12a to 12g which enable easy connection and disconnection between the standard sub-harnesses 20 to 40 and the optional sub-harnesses 50 to 80.

In order to protect the connection unit 10, or to prevent electrical contact between the circuit pattern 11a and peripheral circuits, it is also considered that the connection unit 10 is configured to be accommodated in a suitable housing. The connection unit 10 may be configured such that the periphery of the connection unit 10 is covered with electrical insulating resin or the like.

<Description of Standard Sub-Harness>

The standard sub-harness 20 illustrated in FIG. 13 includes three electrical cables 23a, 23b, and 23c, and connectors 21 and 22 that are connected to both end portions thereof. As a specific example, it is assumed that the electrical cable 23a is used as an electricity supply cable for supplying electricity, the electrical cable 23b is used as a ground cable, and the electrical cable 23c is used as a signal cable or a communication cable.

Each of the electrical cables 23a, 23b, and 23c is configured such that the periphery of a conductor such as a stranded wire is coated with electrical insulating resin or the like. The thickness of the conductor or the thickness and material of the coating of each of the electrical cables 23a, 23b, and 23c is suitably determined according to a current value or a voltage value which changes according to specifications. In the example illustrated in FIG. 13, the three electrical cables 23a, 23b, and 23c are assumed to be standard electrical cables which are mounted in all vehicles. Accordingly, there is one type of standard sub-harness 20.

The standard sub-harness 40 illustrated in FIG. 13 includes an electrical cable group 44 formed of six electrical cables, and three connectors 41, 42, and 43 that are connected to end portions thereof. The six electrical cables of the electrical cable group 44 are assumed to be standard electrical cables which are mounted in all the vehicles. Accordingly, there is one type of standard sub-harness 40.

Each of the six electrical cables of the electrical cable group 44 is used as an electricity supply cable, a ground cable, a signal cable, a communication cable, or the like.

The standard sub-harness 30 illustrated in FIG. 13 includes an electrical cable group 34a; an electrical cable 34b; an electrical cable group 34c; the connector 31; and connectors 32 and 33. The electrical cable group 34a is formed of four electrical cables, and the electrical cable group 34c is formed of two electrical cables.

In the standard sub-harness 30 illustrated in FIG. 13, the electrical cable groups 34a and 34b are standard electrical cables which are mounted in all the vehicles, and the electrical cable group 34c is selectively used according to the required specifications of the wiring harness 100, that is, according to the type, grade, or existence and non-existence of various options of a vehicle. Accordingly, there is a possibility that two or more types (part numbers) of standard sub-harness 30 have to be prepared in advance.

<Description of Optional Sub-Harness>

The optional sub-harness 50 illustrated in FIG. 13 includes an electrical cable 53 and two connectors 51 and 52 that are connected to both end portions thereof. The length of the electrical cable 53, the shape of the connector 51, and the like are determined according to specifications of the optional sub-harness 50.

The optional sub-harness 60 illustrated in FIG. 13 includes an electrical cable group 63 and two connectors 61 and 62 that are connected to both end portions thereof. The electrical cable group 63 is formed of two electrical cables. The length of the electrical cable group 63, the shape of the connector 61, and the like are determined according to specifications of the optional sub-harness 60.

The optional sub-harness 70 illustrated in FIG. 13 includes an electrical cable 73 and two connectors 71 and 72 that are connected to both end portions thereof. The length of the electrical cable 73, the shape of the connector 71, and the like are determined according to specifications of the optional sub-harness 70.

The optional sub-harness 80 illustrated in FIG. 13 includes an electrical cable 83 and two connectors 81 and 82 that are connected to both end portions thereof. The length of the electrical cable 83, the shape of the connector 82, and the like are determined according to specifications of the optional sub-harness 80.

Basically, there is one type of each of the optional sub-harnesses 50, 60, 70, and 80; however, as necessary, two or more types of each of the optional sub-harnesses 50, 60, 70, and 80 may be prepared.

<Advantages of Wiring Harness 100 of First Example of Third Embodiment>

Each of various sub-harnesses of a wiring harness in the related art includes various standard circuit cables which are common to all vehicles, and various optional circuit cables which are selectively added according to a vehicle type, a grade, or the existence and non-existence of various options. For this reason, the number of part numbers of sub-harnesses which have to be prepared exponentially increases to the extent that the number of selective circuit cables provided in a wiring harness increases. In contrast, in the wiring harness 100 illustrated in FIG. 12, as illustrated in FIG. 13, the standard sub-harnesses 20 to 40 formed of standard circuit cables are sub-harnesses different from the optional sub-harnesses 50 to 80 formed of selective circuit cables. In a case where sub-harnesses are formed in this manner, even if the number of selective circuit cables increases by n, the number of part numbers of the sub-harnesses increases by n. As such, it is possible to prevent a significant increase in the number of part numbers of sub-harnesses in comparison with an increase in the number of part numbers of sub-harnesses in the related art.

In the wiring harness 100 illustrated in FIG. 12, the circuit substrate 11 of the connection unit 10 serves to connect together the circuit cables of the sub-harnesses. That is, the connection pattern of the circuit cables is determined by the circuit substrate 11. For this reason, it is not necessary to provide branch cables in each sub-harness, and thus, the shape of each sub-harness without branch cables becomes simple. As a result, it is possible to manufacture sub-harnesses at cheaper prices. In contrast, a circuit pattern for connecting together all the circuit cables is required to be provided on the circuit substrate 11. Even if the maximum total number of circuit cables is estimated, the price of the circuit substrate 11 is not high. As a result, the entire configuration of a wiring harness becomes simplified, and thus, it is possible to provide a wiring harness at a cheaper price.

Since the shapes of the sub-harnesses become simplified which include a small number of branch cables, it is possible to increase similarity between the shapes of multiple sub-harnesses. This means that the sub-harnesses have high versatilities. As a result, a sub-harness can be used in common, for example, a sub-harness can be used in a wiring harness at multiple locations, or a sub-harness used in a wiring harness can be used in a separate wiring harness. This means that a common sub-harness can be used in various wiring harnesses.

The reason a sub-harness can be used in common as described above is that the circuit substrate 11 serves to connect together circuit cables. The circuit substrate 11 has not only a so-called joint function for connecting together circuit cables, but also a rectification function for adjusting a connection relationship in which multiple circuit cables which have to be connected together are selected. If circuit substrates having different circuit patterns are prepared, it is possible to arbitrarily switch a connection relationship between circuit cables.

This means that the required specifications of a wiring harness are switched by a circuit pattern of a circuit substrate. A sub-harness can be used in common, and since specification change functions are consolidated into a circuit substrate, a wiring harness can be used in common in various grades and options of vehicles, and a wiring harness can be used in common in various vehicle types. A wiring harness in the related art is designed for each vehicle type, and in contrast, the designing of the wiring harness 100 illustrated in FIG. 12 can be performed without being constrained by a framework called a vehicle type.

Hereinafter, advantages of the wiring harness 100 in terms of operation efficiency in the manufacturing of a wiring harness will be ascertained. Each of the multiple standard sub-harnesses 20 to 40 of the wiring harness 100 is realized by connecting together two electrical cables, one of which forms the sub-harness (A1, A2, or B2 in FIG. 17) in the related art. For this reason, the electrical cable length of each of the standard sub-harnesses 20 to 40 is shorter than that of the sub-harness in the related art. This means that the length of one electrical cable along a routing path when an operator routes a sub-harness on a jig plate is short. If the length of an electrical cable is long, an operator has to move further by that extent. A short length of an electrical cable contributes to an improvement in efficiency of an operation of routing a sub-harness.

### Second Example of Third Embodiment

### Entire Configuration of Wiring Harness

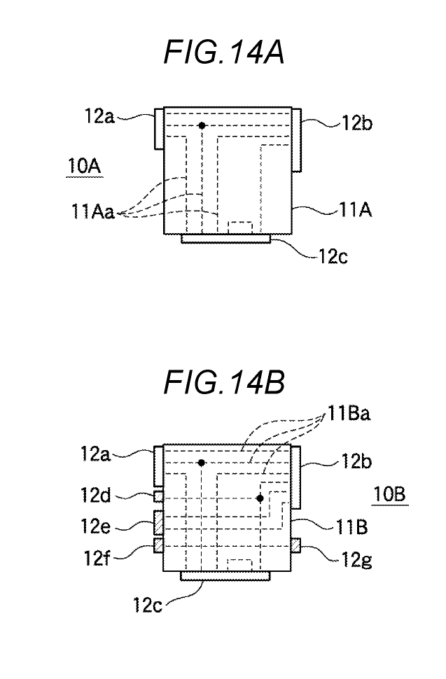

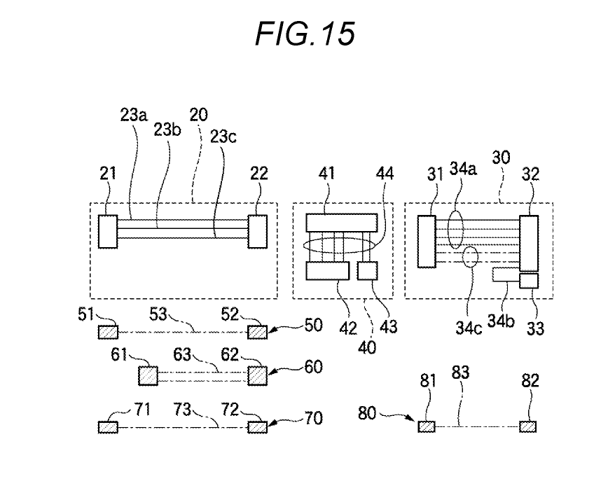

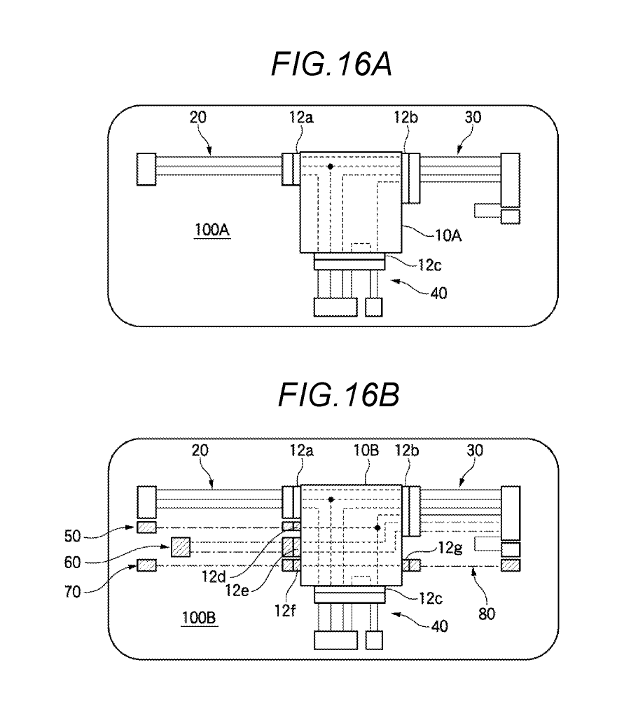

FIGS. 14A and 14B illustrate the configurations of two types of connection units which can be used to form a wiring harness in a second example of the third embodiment. FIG. 15 illustrates the configuration of each sub-harness group that can be used to form the wiring harness in the second example of the third embodiment. FIGS. 16A and 16B illustrate examples of the configurations of two types of wiring harness in the second example of the third embodiment. In FIGS. 14 to 16, for easy understanding of the configuration, each electrical cable is illustrated as being shorter than an actual length. It is assumed that electrical cables of suitable lengths in a range of 10 [cm] to several hundreds [cm] are used as necessary in an actual wiring harness.

A wiring harness 100A illustrated in FIG. 16A is formed of a combination of one connection unit 10A and three standard sub-harnesses 20, 30, and 40. A wiring harness 100B illustrated in FIG. 16BS is formed of a combination of one connection unit 10B, the three standard sub-harnesses 20, 30, and 40, and four optional sub-harnesses 50, 60, 70, and 80.

The connection unit 10A is selectively used to form the wiring harness 100A, and the connection unit 10B is selectively used to form the wiring harness 100B. The connection unit 10A illustrated in FIG. 14A and the connection unit 10B illustrated in FIG. 14B respectively adopt circuit substrates 11A and 11B, the circuit patterns of which are different from each other.

Specifically, a connector 22 connected to a first end of the standard sub-harness 20 prepared in advance is connected to a substrate side connector 12a of the connection unit 10A or 10B. A connector 31 connected to a first end of the standard sub-harness 30 prepared in advance is connected to a substrate side connector 12b of the connection unit 10A or 10B. A connector 41 connected to a first end of the standard sub-harness 40 prepared in advance is connected to a substrate side connector 12c of the connection unit 10A or 10B. A connector 52 of the optional sub-harness 50 is connected to a substrate side connector 12d of the connection unit 10B. A connector 62 of the optional sub-harness 60 is connected to a substrate side connector 12e of the connection unit 10. A connector of the optional sub-harness 70 is connected to a substrate side connector 12f of the connection unit 10. A connector 81 of the optional sub-harness 80 is connected to a substrate side connector 12g of the connection unit 10.

That is, all end portions of the three standard sub-harnesses 20 to 40 of the wiring harness 100A are physically connected to the connection unit 10A. All end portions of the three standard sub-harnesses 20 to 40 and the four optional sub-harnesses 50 to 80 of the wiring harness 100B are physically connected to the connection unit 10B. Accordingly, electrical cables of the standard sub-harnesses 20 to 40 and the optional sub-harnesses 50 to 80 can be electrically connected to each other via a circuit pattern (to be described later) provided in the connection unit 10A or 10B.

The wiring harness 100 illustrated in FIG. 12 includes the connection unit 10; the three standard sub-harnesses 20 to 40; and the four optional sub-harnesses 50 to 80. The four optional sub-harnesses 50 to 80 are selectively connected to the connection unit 10. In a case where the optional sub-harnesses 50 to 80 are not connected, the connection unit 10A is selectively used. In a case where the optional sub-harnesses 50 to 80 are connected, the connection unit 10B is selectively used.

That is, a difference between connection patterns of circuit cables caused by a change in wiring harness specifications changing according to the type, grade, or existence and non-existence of various options of a vehicle in which a wiring harness is mounted is absorbed by a difference between the circuit patterns of the connection units 10A and 10B. The four optional sub-harnesses 50 to 80 are selectively connected to the connection unit 10B, and as a result, the wiring harness 100A or 100B illustrated in FIG. 16A or 16B which is suitable for the specifications is formed.

<Description of Each Configuration Element>

<Description of Connection Units 10A and 10B>

The connection unit 10A illustrated in FIG. 14A includes a circuit substrate 11A that is formed of a thin plate and has a rectangular planar shape, and multiple substrate side connectors 12a to 12c which are mounted on the circuit substrate 11A. Specifically, the circuit substrate 11A is formed of a printed substrate including an electrical insulating substrate 11b and a circuit pattern 11a formed on this substrate. In a case where the circuit pattern 11a having a relative complex configuration is formed, the circuit substrate 11 is formed of a multi-layer printed substrate.

The connection unit 10B illustrated in FIG. 14B includes a circuit substrate 11B and multiple substrate side connectors 12a to 12g which are mounted on the circuit substrate 11B. Only a difference between the circuit substrate 11A and the circuit substrate 11B is a difference between circuit patterns 11Aa and 11Ba which are respectively formed thereon.

Each of the circuit patterns 11Aa and 11Ba is formed of a foil-shaped conductive pattern such as a copper foil sticking to a front surface or a rear surface of the electrical insulating substrate 11b, or boundary surfaces between layers in a thickness direction. As illustrated by dotted lines in FIGS. 14A and 14B, each of the circuit patterns 11Aa and 11Ba includes many wirings through which the substrate side connectors 12a to 12g are connected to each other. As illustrated in FIGS. 14A and 14B, the circuit patterns 11Aa and 11Ba are different from each other. That is, the circuit pattern 11Aa is configured such that connection between the circuit cables is realized according the specifications of the wiring harness 100A illustrated in FIG. 16A. The circuit pattern 11Ba is configured such that connection between the circuit cables is realized according to the specifications of the wiring harness 100B illustrated in FIG. 16B.

Many wirings in each of the circuit patterns 11Aa and 11Ba are electrically separated from each other, and portions of the wirings are electrically connected to each other. In a case where multiple wirings are required to be electrically separated from each other at intersecting locations on a plane illustrated in FIG. 14A or 14B, the wirings are disposed on different surfaces or layers such that the wirings are electrically separated from each other. In a case where wirings disposed on different surfaces or layers are required to be connected to each other, electrical connection therebetween is realized via through holes passing through the electrical insulating substrate 11b in the thickness direction.

The connection units 10A and 10B illustrated in FIGS. 14A and 14B include the substrate side connectors 12a to 12g which enable easy connection and disconnection between the standard sub-harnesses 20 to 40 and the optional sub-harnesses 50 to 80.

In order to protect the connection units 10A and 10B, or to prevent electrical contact between the circuit patterns 11Aa and 11Ba and peripheral circuits, it is also considered that the connection units 10A and 10B are configured to be respectively accommodated in suitable housings. The connection units may be configured such that the peripheries of the connection units are covered with electrical insulating resin or the like.

<Description of Standard Sub-Harness>

The standard sub-harness 20 illustrated in FIG. 15 includes three electrical cables 23a, 23b, and 23c, and connectors 21 and 22 that are connected to both end portions thereof. As a specific example, it is assumed that the electrical cable 23a is used as an electricity supply cable for supplying electricity, the electrical cable 23b is used as a ground cable, and the electrical cable 23c is used as a signal cable or a communication cable.

Each of the electrical cables 23a, 23b, and 23c is configured such that the periphery of a conductor such as a stranded wire is coated with electrical insulating resin or the like. The thickness of the conductor or the thickness and material of the coating of each of the electrical cables 23a, 23b, and 23c is suitably determined according to a current value or a voltage value which changes according to specifications. In the example illustrated in FIG. 15, the three electrical cables 23a, 23b, and 23c are assumed to be standard electrical cables which are mounted in all vehicles. Accordingly, there is one type of standard sub-harness 20.

The standard sub-harness 40 illustrated in FIG. 15 includes an electrical cable group 44 formed of six electrical cables, and three connectors 41, 42, and 43 that are connected to end portions thereof. The six electrical cables of the electrical cable group 44 are assumed to be standard electrical cables which are mounted in all the vehicles. Accordingly, there is one type of standard sub-harness 40.

Each of the six electrical cables of the electrical cable group 44 is used as an electricity supply cable, a ground cable, a signal cable, a communication cable, or the like.

The standard sub-harness 30 illustrated in FIG. 15 includes an electrical cable group 34a; an electrical cable 34b; an electrical cable group 34c; the connector 31; and connectors 32 and 33. The electrical cable group 34a is formed of four electrical cables, and the electrical cable group 34c is formed of two electrical cables.

In the standard sub-harness 30 illustrated in FIG. 15, the electrical cable groups 34a and 34b are standard electrical cables which are mounted in all the vehicles, and the electrical cable group 34c is selectively used according to the required specifications of the wiring harness 100, that is, according to the type, grade, or existence and non-existence of various options of a vehicle. Accordingly, there is a possibility that two or more types (part numbers) of standard sub-harness 30 have to be prepared in advance.

<Description of Optional Sub-harness>

The optional sub-harness 50 illustrated in FIG. 15 includes an electrical cable 53 and two connectors 51 and 52 that are connected to both end portions thereof. The length of the electrical cable 53, the shape of the connector 51, and the like are determined according to specifications of the optional sub-harness 50.

The optional sub-harness 60 illustrated in FIG. 15 includes an electrical cable group 63 and two connectors 61 and 62 that are connected to both end portions thereof. The electrical cable group 63 is formed of two electrical cables. The length of the electrical cable group 63, the shape of the connector 61, and the like are determined according to specifications of the optional sub-harness 60.

The optional sub-harness 70 illustrated in FIG. 15 includes an electrical cable 73 and two connectors 71 and 72 that are connected to both end portions thereof. The length of the electrical cable 73, the shape of the connector 71, and the like are determined according to specifications of the optional sub-harness 70.

The optional sub-harness 80 illustrated in FIG. 15 includes an electrical cable 83 and two connectors 81 and 82 that are connected to both end portions thereof. The length of the electrical cable 83, the shape of the connector 82, and the like are determined according to specifications of the optional sub-harness 80.

Basically, there is one type of each of the optional sub-harnesses 50, 60, 70, and 80; however, as necessary, two or more types of each of the optional sub-harnesses 50, 60, 70, and 80 may be prepared. For example, since there may be a significant difference between distances among electrical components, it is necessary to prepare the optional sub-harnesses 50 to 80 having different lengths in advance so as to form the wiring harness 100 that is mounted in multiple types of vehicles having vehicle bodies of significantly different sizes.

### Advantages of Wiring Harnesses 100A and 100B of

### Second Example of Third Embodiment

In a case where the wiring harnesses 100A and 100B illustrated in FIGS. 16A and 16B are formed, it is possible to change the state of electrical connection between multiple sub-harnesses merely by replacing the circuit patterns 11Aa and 11Ba of the circuit substrates 11A and 11B, which are portions of the wiring harnesses, with each other. For example, in a case where the circuit substrate 11B illustrated in FIG. 14B is selected, as in the wiring harness 100B illustrated in FIG. 16B, the circuit cables of the optional sub-harnesses 50, 60, and 70 can be connected to the circuit cable of the standard sub-harness 30, and the circuit cables of the optional sub-harness 50 can be connected to the circuit cables of the standard sub-harness 40. In a case where the circuit substrate 11A illustrated in FIG. 14A is selected, only the circuit cables of the standard sub-harnesses 20, 30, and 40 can be connected together.

Accordingly, it is possible to form various specifications of wiring harnesses by using multiple sub-harnesses of a relatively small number of types or the numbers of part numbers in common. That is, since it is possible to use a sub-harness with the same configuration in multiple specifications of wiring harnesses, it is possible to considerably reduce the number of types or part numbers of sub-harnesses which have to be prepared in advance.

The aforementioned characteristics of the wiring harness according to the third embodiment are briefly summarized and listed in [1] to [5].

[1] A wiring harness (100A) includes a first sub-harness (standard sub-harness 30) including first circuit cables, a second sub-harness (standard sub-harness 40) including second circuit cables, a third sub-harness (optional sub-harness 50, 60, or 70) including third circuit cables, and a circuit substrate (11A or 11B) on which a circuit pattern (10a), which can be connected to at least two of the first sub-harness, the second sub-harness, and the third sub-harness, is formed. A first circuit substrate (11A) and a second circuit substrate (11B) on which different circuit patterns are respectively formed are prepared as the circuit substrates. In a case where the first sub-harness and the second sub-harness are connected to the first circuit substrate, the first circuit cables and the second circuit cables are conductively connected together via the circuit pattern on the first circuit substrate. In a case where the first sub-harness and the third sub-harness are connected to the second circuit substrate, the first circuit cables and the third circuit cables are conductively connected together via the circuit pattern on the second circuit substrate.

[2] In the wiring harness described in [1], the wiring harness further includes a fourth sub-harness (optional sub-harness 80) including fourth circuit cables, in which in a case where the third sub-harness and the fourth sub-harness are connected to the second circuit substrate, the third circuit cables and the fourth circuit cables are conductively connected together via the circuit pattern on the second circuit substrate.

[3] In the wiring harness described in [1], each of the first circuit substrate and the second circuit substrate includes multiple connection portions (substrate side connectors 12a to 12g) which are attachably and detachably connected to at least two of the first sub-harness, the second sub-harness, and the third sub-harness.

[4] In the wiring harness described in any one of [1] to [3], the circuit substrate is a printed substrate that includes an electrical insulating substrate and a foil-shaped conductive pattern sticking to at least one surface of the substrate.

[5] In the wiring harness described in [4], the circuit substrate is a multi-layer printed substrate which includes multiple electrical insulating layers that are disposed while being superimposed on top of each other in a thickness direction, and in which the multiple foil-shaped patterns electrically separated from each other are respectively formed at the boundaries and on front surfaces of the multiple electrical insulating layers.

The present invention has been described in detail with reference to the specific embodiments; however, it is apparent to persons skilled in the art that changes or corrections can be made to the embodiments in various forms insofar as the changes or corrections do not depart from the concept and scope of the present invention.

### INDUSTRIAL APPLICABILITY

According to the present invention, it is possible to provide a wiring harness routing structure in which the manufacturing, handling, and routing of a wiring harness are easy. The present invention providing this effect is effective for a wiring harness routing structure.

### REFERENCE SIGNS LIST

110: WIRING HARNESS ROUTING STRUCTURE
120: BEAM (WIRING HARNESS ROUTING MEMBER)
121: SHAFT PORTION
123: BRACKET (FIXING MECHANISM)
123a: ENGAGEMENT HOLE
130: WIRING HARNESS
131: MAIN CABLE
132: BRANCH CABLE
133: JOINT CONNECTOR
134: CONNECTOR
140: PROTECTOR
141: MAIN CABLE ACCOMMODATION PORTION
142: BRANCH CABLE ACCOMMODATION PORTION
143: JOINT CONNECTOR ACCOMMODATION PORTION
144: CLIP (FIXING MECHANISM)
145: SLIT
146: LOCK ARM
146a: CLAW PORTION
10, 10A, 10B: CONNECTION UNIT
11, 11A, 11B: CIRCUIT SUBSTRATE
11a, 11Aa, 11Ba: CIRCUIT PATTERN
11b: ELECTRICAL INSULATING SUBSTRATE
12a, 12b, 12c, 12d, 12e, 12f, 12g: SUBSTRATE SIDE CONNECTOR
20, 30, 40: STANDARD SUB-HARNESS
21, 22, 31, 32, 33, 41, 42, 43: CONNECTOR
23a, 23b, 23c, 34b, 53, 73, 83: ELECTRICAL CABLE
34a, 34c, 44, 63: ELECTRICAL CABLE GROUP
50, 60, 70, 80: OPTIONAL SUB-HARNESS
51, 52, 61, 62, 71, 72, 81, 82: CONNECTOR
100, 100A, 100B, WH: WIRING HARNESS
SHG: SUB-HARNESS GROUP
A1, A2, B1, B2, C: SUB-HARNESS

What is claimed is:

1. A wiring harness routing structure comprising:
a wiring harness routing member configured to be attached to a vehicle body; and
a protector that accommodates and holds a wiring harness,
wherein the protector has a recess shape in which the protector is opened in one direction in a sectional view,
wherein at least one of the wiring harness routing member and the protector includes a fixing mechanism that fixes the protector to the wiring harness routing member, and
wherein the protector and the wiring harness routing member are configured to be integrated via the fixing mechanism.

2. The wiring harness routing structure according to claim 1,
wherein the protector includes a contact surface which is configured to be in contact with the wiring harness routing member, and
wherein the contact surface of the protector has a shape conforming to a shape of a contact surface of the wiring harness routing member.

3. The wiring harness routing structure according to claim 1,
wherein the fixing mechanism includes a bracket provided with the wiring harness routing member, and a clip formed integrally with the protector and including a hole portion that is engaged with the bracket.

4. The wiring harness routing structure according to claim 1,
wherein the wiring harness includes a joint connector with a rectification function, and
wherein the protector includes a joint connector accommodation portion.

5. The wiring harness routing structure according to claim 1,
wherein the protector includes a main cable accommodation portion that accommodates a main cable of the wiring harness, and a branch cable accommodation portion that accommodates a branch cable of the wiring harness.
